(19) United States
(12) Patent Application Publication
(10) Pub. No.: US 2009/0092418 A1
(43) Pub. Date: Apr. 9, 2009

(54) Developing Method, Image Forming Method and Image Forming Apparatus

(75) Inventor: Hiroshi TOYAMA, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/247,898

(22) Filed: Oct. 8, 2008

(30) Foreign Application Priority Data
Oct. 9, 2007 (JP) 2007-263129
Jun. 20, 2008 (JP) 2008-161095

(51) Int. Cl. G03G 15/10

(52) U.S. Cl. 399/240

(57) ABSTRACT

A developing method includes a step of driving a developing roller to rotate and supplying liquid developer stored in a liquid developer container to the developing roller, a step of applying a bias to a toner charger to electrically charge the liquid developer supplied to the developing roller, a step of driving the developing roller to rotate so as to move the liquid developer electrically charged by the toner charger to a developing position and subsequently bringing the developing roller into contact with a latent image carrier electrically charged by a charger and a step of developing the latent image, holding the developing roller in contact with the latent image carrier.

### CROSS-REFERENCE TO RELATED APPLICATIONS

This application is based upon and claims the benefit of priority from prior Japanese Patent Application No. 2007-263129, filed Oct. 9, 2007, and Japanese patent Application No. 2008-161095, filed Jun. 20, 2008, the entire contents of which are incorporated herein by reference.

### BACKGROUND OF THE INVENTION

1. Field of the Invention

This invention relates to a developing method adapted to develop a latent image by means of a liquid developer and reutilize the used liquid developer after the image transfer and also to an image forming method using such a developing method. The present invention also relates to a developing system adapted to develop a latent image by means of a liquid developer and reutilize the used liquid developer after the image transfer and also to an electro-photographic image forming apparatus such as a copying machine, a facsimile machine, a printer or the like that employs such a developing system.

2. Description of the Related Art

Various image forming apparatus for forming an image by means of a liquid developer have been proposed to date. Such a liquid developer is prepared by dispersing a toner that is made of resin and a pigment into a liquid carrier (carrier oil). JP-A-2006-251670 (to be referred to as Document 1 hereinafter) discloses an image forming apparatus adapted to use such a liquid developer and reutilize the liquid developer removed and collected from a photosensitive member by means of a photosensitive member cleaner after the image transfer.

Image forming apparatus designed to use a liquid developer and adopt a developing system of carrying a liquid developer to a developing nip section between a photosensitive member and a developing roller by means of the developing roller are known. JP-A-2007-114380 (to be referred to as Document 2 hereinafter) discloses a developing system of applying an electric charge to the toner in the liquid developer borne on a developing roller by means of a compaction roller (toner charger). The toner concentration in the liquid carrier being carried to the developing nip section is controlled by applying an electric charge to the toner.

Meanwhile, an image forming apparatus disclosed in Document 1 is also required to control the toner concentration in the liquid developer being carried to the developing nip section. Thus, it is conceivable to control the toner concentration of the liquid developer by applying an electric charge to the toner in the liquid carrier as in the case of a developing system disclosed in Document 2.

However, when reutilizing a liquid developer, the electric charge of the toner is attenuated as time passes from the last printing session. Then, when the current printing session is started, the toner on the developing roller may not have an electric charge of a predetermined level. Additionally, no electric charge is applied by the toner charger to the toner to be reutilized out of the toner on the developing roller located at the side of the developing nip section (the nip section formed by the developing roller and the photosensitive member) relative to the toner charger. Then, as a result, the electric charge of the toner to be reutilized cannot be held to a predetermined constant level. Particularly, as the developing roller is constantly held in contact with the photosensitive member, the toner can be moved to the photosensitive member to make the image concentration instable.

Additionally, when reutilizing a liquid developer, toners of different colors can be mixed to give rise to a problem of color mixing. A color mixing problem takes place mainly at the time of starting a printing operation. This is most probably because the toner having no electric charge on the developing roller, to which no electric charge has been applied by the toner charger, is controlled neither by the development bias at the developing nip section nor by the transfer bias at the transfer nip section (the nip section formed by the photosensitive member and the target of transfer).

On the other hand, in an image forming apparatus using a liquid developer, a toner is moved from the developing roller to the photosensitive member during the development process and the toner on the photosensitive member is transferred to the intermediate transfer belt and then to the target of transfer, which may typically be a sheet of paper, during the transfer process. However, if the toner having no electric charge is not controlled by a bias, the toner on the target of transfer can partly be moved to the photosensitive member bearing the next color, which is different from the current color. The toner moved to the photosensitive member bearing the different color is then collected with the residual toner of the color borne on the photosensitive member. Then, the mixed toners of the different colors are reutilized to give rise to a color mixing problem.

### SUMMARY OF THE INVENTION

Therefore, a first object of the present invention is to provide a developing method, an image forming method and an image forming apparatus that can produce an improved image concentration if a collected liquid developer is reutilized.

A second object of the present invention is to provide a developing method, an image forming method and an image forming apparatus that can effectively prevent the color mixing problem of toners at the time of starting a printing operation if a collected liquid developer is reutilized.

According to the present invention, the above objects are achieved by providing a developing method, an image forming method and an image forming apparatus by means of which the developing roller of the image forming apparatus is held in a state of being separated from a latent image carrier when the apparatus is not operating for forming an image. Both the latent image carrier and the developing roller are driven to rotate in this state at the time when a developing process is started. The liquid developer in the liquid developer container is supplied to the developing roller. Additionally, the toner charging bias is applied to the toner charger and the toner of the liquid developer on the developing roller is electrically charged by the toner charger. After the charged toner on the developing roller passes the contact position of the developing roller and the latent image carrier, the developing roller is brought into contact with the latent image carrier. Therefore, the toner on the developing roller is transferred onto the latent image carrier by the development bias in a state of being reliably electrically charged. As a result, the electrostatic latent image on the latent image carrier is developed to form a toner image on the latent image carrier. After the transfer of the toner image, the liquid developer remaining on the latent image carrier is collected into the liquid developer container by means of a liquid developer collecting device for reuse.

Since the electrostatic latent image on the latent image carrier is developed in a state where the toner on the developing roller is reliably electrically charged in this way, an improved image concentration can be produced if the collected liquid developer is reutilized.

With an image forming method and an image forming apparatus according to the present invention, the developing rollers of the different colors convey the liquid developers in the corresponding respective liquid developers to the latent image carrier during a developing process. Then, as a result, the electrostatic latent images of the different colors are developed by the liquid developers of the respective colors. The liquid developer remaining on the latent image carrier after the transfer of the latent image of the corresponding color is collected into the corresponding liquid developer container by means of the corresponding liquid developer collecting device for reuse.

Particularly, before the start of a developing process, the developing roller of each of the different colors is held in a state of being separated from the corresponding one of the latent image carriers. Then, both the latent image carrier and the developing roller of the color are driven to rotate in this state at the time when a developing process is started. The toner charging bias is applied to the toner charger and the toner of the liquid developer of the color on the developing roller is electrically charged by the toner charger. After the charged toner on the developing roller passes the contact position of the developing roller and the latent image carrier, the developing roller is brought into contact with the latent image carrier. Therefore, the toner of the color on the developing roller is transferred onto the latent image carrier by the development bias in a state of being reliably electrically charged. As a result, the electrostatic latent image on the latent image carrier is developed to form a toner image on the latent image carrier. Additionally, the toner image on the latent image carrier is transferred onto a target of transfer by the transfer bias. Thus, a toner image is formed on the target of transfer.

Meanwhile, the electrically charged toner image is controlled by the development bias and the transfer bias. Therefore, the toner on the target of transfer is prevented from being moved onto the photosensitive member of the next color that is different from the current color if partly. Thus, if the collected liquid developer is reutilized, any problem of color mixing of toners can be effectively prevented from taking place at the time of starting a printing process.

Additionally, after ending a developing process, the developing rollers are separated from the corresponding respective latent image carriers while both the latent image carriers and the developing rollers are rotating. Then, the application of the toner charging bias to the toner charger is suspended while the developing roller of each color is held in a state of being separated from the corresponding latent image carrier. Thereafter, both the rotation of the developing roller and that of the latent image carrier are stopped. In other words, both the rotation of the latent image carrier and that of the developing roller are stopped in a state where no liquid developer can move from the developing roller to the latent image carrier. Thus, as a result, color mixing of toners of different colors is suppressed to prevent toners of different colors from mixing with each other very effectively.

Still additionally, after ending a developing process, both the rotation of the developing rollers of and that of the latent image carriers are stopped when the liquid developer on the latent image carrier of the first color has passed the transfer unit of the last color. Thus, as a result, the color mixing of the toners of different colors remaining on the latent image carriers is suppressed after the transfers of the colors to prevent toners of different colors from mixing with each other. Therefore, toners of different colors are prevented from mixing with each other further effectively.

Still additionally, after ending a developing process, the rotation of the latent image carriers, that of the developing rollers and that of the intermediate transfer medium are all stopped in a state where the liquid developer on the latent image carrier of the first color has been transferred onto the intermediate transfer medium by the corresponding primary transfer unit and the liquid developer on the intermediate transfer medium has passed the secondary transfer unit. Thus, as a result, the color mixing of the toners of different colors remaining on the latent image carriers and those of different colors remaining on the intermediate transfer medium is suppressed after the transfers of the colors to prevent toners of different colors from mixing with each other. Therefore, toners of different colors are prevented from mixing with each other further effectively.

Furthermore, after ending a developing process, the rotation of the latent image carriers, that of the developing rollers and that of the intermediate transfer medium are all stopped in a state where the liquid developer on the latent image carrier of the first color has been transferred onto the intermediate transfer medium by the corresponding primary transfer unit and the liquid developer on the intermediate transfer medium has passed the intermediate transfer medium cleaning member. Thus, as a result, the color mixing of the toners of different colors remaining on the latent image carriers and those of different colors remaining on the intermediate transfer medium is suppressed after the transfers of the colors to prevent toners of different colors from mixing with each other. Therefore, toners of different colors are prevented from mixing with each other further effectively.

### BRIEF DESCRIPTION OF THE DRAWINGS

The invention will be described with reference to the accompanying drawings, wherein like members reference like elements.

FIG. 1 is a schematic partial view of an embodiment of image forming apparatus according to the present invention;

FIG. 2 is an enlarged partial view of the image forming sections of FIG. 1;

FIG. 3 is a schematic perspective view of the image forming sections of FIG. 1, illustrating the operation of collecting liquid developers;

FIG. 4 is a schematic illustration of the reutilization of collected liquid developers;

FIG. 5 is a chart illustrating the sequence control of the image forming sections for a printing operation;

FIG. 6 is a chart illustrating part of the sequence control of Example 1;

FIG. 7 is a chart illustrating part of the sequence control of Example 2;

FIG. 8 is a chart illustrating part of the sequence control of Example 3;

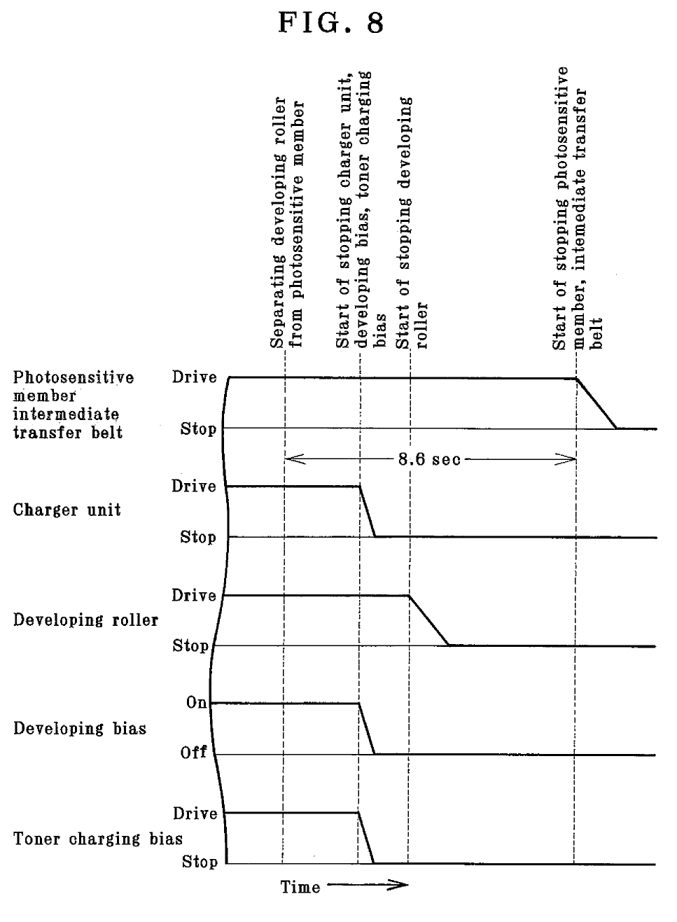

FIG. 9 is an enlarged schematic partial view of the image forming sections of another embodiment of image forming apparatus according to the present invention, illustrating a state where the developing rollers are separated from the corresponding respective photosensitive members;

FIG. 10 is an enlarged schematic partial view of the image forming sections of the embodiment of FIG. 9, illustrating a state where the developing rollers are held in contact with the corresponding respective photosensitive members;

FIG. 11 is a schematic perspective view of the liquid developer containers; and

FIG. 12 is a chart illustrating the sequence control of the image forming sections for a printing operation of the image forming sections according to the embodiment of FIG. 9;

FIG. 13 is a chart illustrating the sequence control of the image forming apparatus of FIG. 9 for an operation of printing an image on a sheet of printing medium.

### DESCRIPTION OF EXEMPLARY EMBODIMENTS

Now, the present invention will be described in greater detail by referring to the accompanying drawings that schematically illustrate exemplary embodiments of the invention.

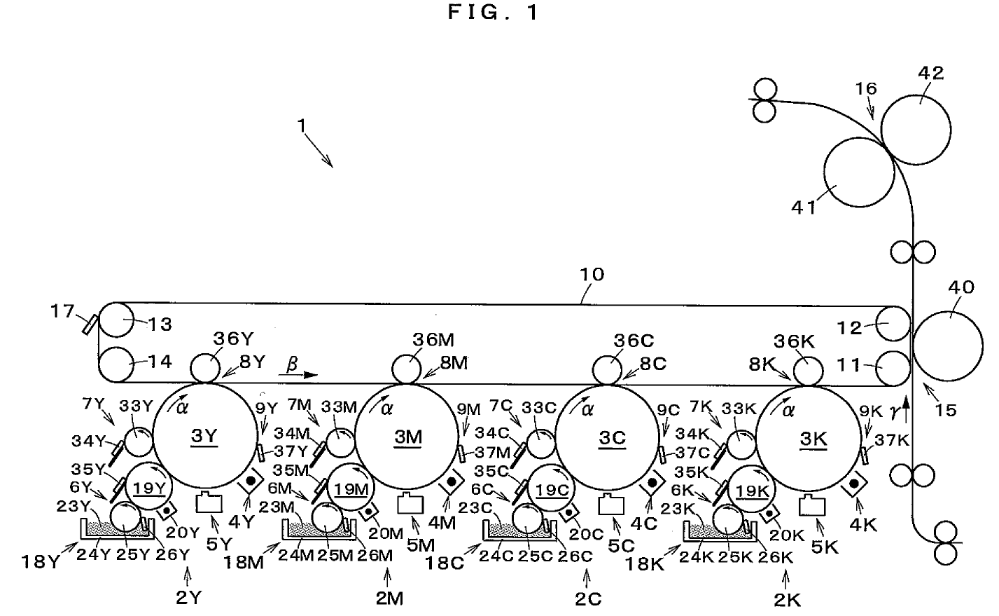

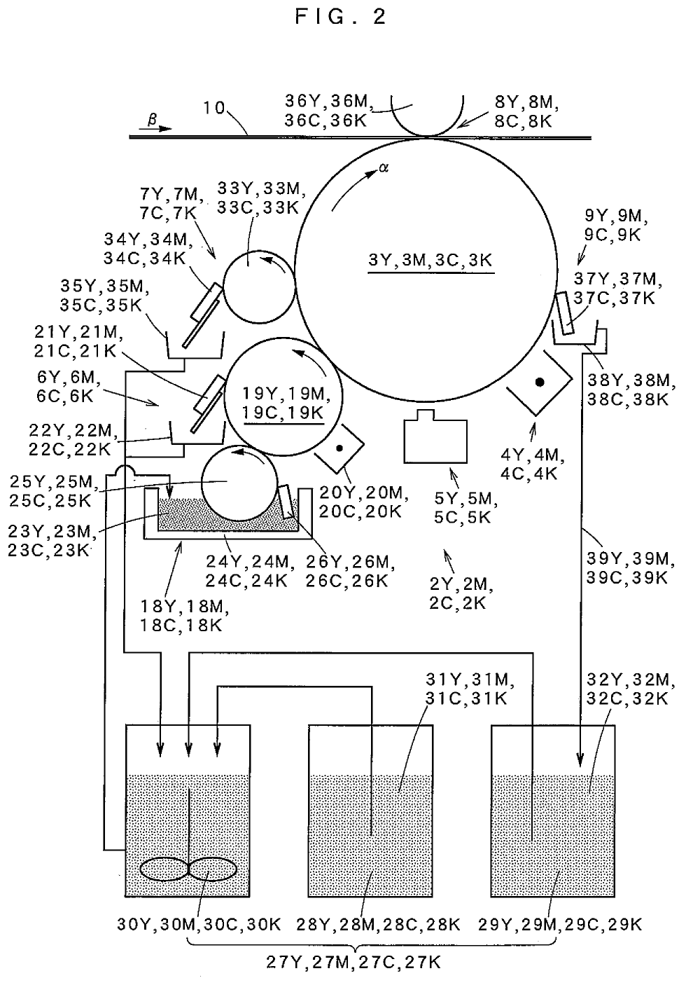

FIG. 1 is a schematic partial view of an embodiment of image forming apparatus according to the present invention. FIG. 2 is an enlarged partial view of the image forming sections of FIG. 1. All the image forming sections have the same configuration and the components of the image forming sections are commonly illustrated and suffixed by the color discriminating signs Y, M, C and K which indicate the different colors of yellow, magenta, cyan and black respectively.

As shown in FIGS. 1 and 2, the image forming apparatus 1 of the present embodiment has image forming sections 2Y, 2M, 2C and 2K of yellow (Y), magenta (M), cyan (C) and black (K) that are arranged side by side.

The image forming sections 2Y, 2M, 2C and 2K respectively have photosensitive members 3Y, 3M, 3C and 3K that are so many latent image carriers. In the image forming apparatus 1 of this embodiment, the photosensitive members 3Y, 3M, 3C and 3K are formed by using respective photosensitive drums. The photosensitive members 3Y, 3M, 3C and 3K may alternatively be formed by using respective endless belts.

The photosensitive members 3Y, 3M, 3C and 3K are adapted to be driven in the sense indicated by arrows α or clockwise in FIGS. 1 and 2. Charging units 4Y, 4M, 4C and 4K are arranged near the outer peripheries of the photosensitive members 3Y, 3M, 3C and 3K respectively. Additionally, exposure units 5Y, 5M, 5C and 5K, developing units 6Y, 6M, 6C and 6K, photosensitive member squeezing units 7Y, 7M, 7C and 7K, primary transfer units 8Y, 8M, 8C and 8K and photosensitive member cleaners 9Y, 9M, 9C and 9K are arranged sequentially downstream relative to the charging units 4Y, 4M, 4C and 4K in the mentioned order respectively in the sense of rotation.

The image forming apparatus 1 additionally has an endless intermediate transfer belt 10 (target of transfer) that is an intermediate transfer medium. The intermediate transfer belt 10 is wound around a belt drive roller 11 to which drive force is transmitted from a motor (not shown) and three follower rollers 12, 13 and 14 so as to be driven to rotate counterclockwise (in the sense indicated by arrow β) in FIG. 1. The follower roller 12 is arranged at a position separated from the belt drive roller 11 by a predetermined distance in the moving direction γ (upward in FIG. 1) of recording medium (target of transfer), which may typically be a sheet of paper. The remaining two follower rollers 13 and 14 are arranged at respective positions separating from the belt drive roller 11 and the follower roller 12 by a predetermined distance in the direction of transversal arrangement of the image forming sections, 2Y, 2M, 2C and 2K. The follower rollers 13 and 14 are also separated from each other by a predetermined distance.

In the instance of the image forming apparatus 1 of this embodiment, the image forming sections 2Y, 2M, 2C and 2K are arranged in the order of the colors of Y, M, C and K from the upstream side, as viewed in the moving direction β of the transferring side of the intermediate transfer belt 10, although the order of arrangement of the colors of Y, M, C and K can be selected arbitrarily.

A secondary transfer unit 15 is arranged at the side of the belt drive roller 11 and the follower roller 12. A fixing unit 16 is arranged at the downstream side of the secondary transfer unit 15 in the sense γ of conveying a recording medium. Additionally, an intermediate transfer belt cleaning device having an intermediate transfer belt cleaning blade 17 (cleaning member) is arranged at the side of the follower roller 13 of the intermediate transfer belt 10.

Although not shown, the image forming apparatus 1 of this embodiment has a recording medium containing unit for containing recording mediums arranged at the upstream side relative to the secondary transfer unit 15 in the sense of conveying a recording medium and a registration roller pair for conveying and supplying a recording medium to the secondary transfer unit 15 like ordinary image forming apparatus whose printing operation involves a secondary transfer. The image forming apparatus 1 additionally has a delivery tray arranged at the downstream side relative to the fixing unit 16.

Each of the charging units 4Y, 4M, 4C and 4K is formed by using a corona charger. A bias showing a polarity same as the polarity of the electric charge of the liquid developer is applied to each of the charging units 4Y, 4M, 4C and 4K from a power source unit (not shown). The charging units 4Y, 4M, 4C and 4K are adapted to uniformly electrically charge the corresponding respective photosensitive members 3Y, 3M, 3C and 3K.

Each of the exposure units 5Y, 5M, 5C and 5K is formed typically by using an LED unit. The exposure units 5Y, 5M, 5C and 5K are adapted to write electrostatic latent images on the corresponding respective photosensitive members 3Y, 3M, 3C and 3K by exposing the photosensitive members to light.

The developing units 6Y, 6M, 6C and 6K respectively have developer supply sections 18Y, 18M, 18C and 18K, developing rollers 19Y, 19M, 19C and 19K, toner charging units (toner chargers) 20Y, 20M, 20C and 20K, developing roller cleaning blades 21Y, 21M, 21C and 21K of developing roller cleaners and reservoir sections 22Y, 22M, 22C and 22K of the liquid collected by developing roller cleaners.

The developer supply sections 18Y, 18M, 18C and 18K respectively have liquid developer containers 24Y, 24M, 24C and 24K for containing liquid developers 23Y, 23M, 23C and 23K containing toner particles of solid toners and liquid carriers, anilox rollers 25Y, 25M, 25C and 25K and developer limiting blades 26Y, 26M, 26C and 26K.

For each of the liquid developers 23Y, 23M, 23C and 23K contained in the respective liquid developer containers 24Y, 24M, 24C and 24K, a known toner having an average particle size of 1 μm that is prepared by dispersing a known pigment into known thermoplastic resin that is popularly being employed for toners. On the other hand, in the case of a low viscosity and low concentration liquid developer, an insulating liquid carrier such as Isopar (trademark, available from Exxon) may be used as liquid carrier. In the case of a high viscosity and high concentration liquid developer, an insulating liquid carrier such as an organic solvent, a silicon oil such as phenylmethylsiloxane, dimethylpolysiloxane or polydimethylcyclosiloxane showing a flash point not lower than 210° C., a mineral oil, an aliphatic saturated hydrocarbon such as a relatively lowly viscous liquid paraffin having a boiling point of not lower than 170° C. and showing a viscosity at 40° C. of 3 mPa·s, normal paraffin, vegetable oil, edible oil or a higher fatty ester may be used. Liquid developers 23Y, 23M, 23C and 23K are prepared by adding toner particles to the respective liquid carriers with a dispersing agent to make the toner solid concentration equal to about 20%.

The anilox rollers 25Y, 25M, 25C and 25K are rollers adapted to respectively make liquid developers 23Y, 23M, 23C and 23K in the liquid developer containers 24Y, 24M, 24C and 24K adhere to the outer peripheral surfaces thereof and supply them to the developing rollers 19Y, 19M, 19C and 19K. Each of these anilox rollers 25Y, 25M, 25C and 25K is a cylindrical member having a helical groove finely uniformly formed on the surface thereof. The groove is typically arranged at a pitch of about 170 μm and with a depth of about 30 μm, although the dimensional values of the groove are not limited thereto. The anilox rollers 25Y, 25M, 25C and 25K are driven to rotate in the sense same as the developing rollers 19Y, 19M, 19C and 19K, or counterclockwise as indicated by arrows in FIGS. 1 and 2. The anilox rollers 25Y, 25M, 25C and 25K may alternatively be driven to rotate in the sense of rotation of the developing rollers 19Y, 19M, 19C and 19K. In short, the sense of rotation of the anilox rollers 25Y, 25M, 25C and 25K are not limited to a single sense of rotation and may be arbitrarily selected.

The developer limiting blades 26Y, 26M, 26C and 26K are held in contact with surfaces of the respective anilox rollers 25Y, 25M, 25C and 25K. Thus, each of the developer limiting blades 26Y, 26M, 26C and 26K are formed by a rubber section typically made of urethane rubber and held in contact with the surface of the corresponding one of the anilox rollers 25Y, 25M, 25C and 25K and a plate typically made of metal and supporting the rubber section. The developer limiting blades 26Y, 26M, 26C and 26K scrape off and remove the liquid developers 23Y, 23M, 23C and 23K adhering to the surfaces of the respective anilox rollers 25Y, 25M, 25C and 25K other than those in the grooves of the anilox rollers by means of the rubber sections. Thus, the anilox rollers 25Y, 25M, 25C and 25K can supply the respective liquid developers 23Y, 23M, 23C and 23K adhering only to the inside of the grooves to the respective developing rollers 19Y, 19M, 19C and 19K.

Each of the developing rollers 19Y, 19M, 19C and 19K is a cylindrical member having a width of about 320 mm that is provided on the outer peripheral section thereof with an elastic member typically made of electro-conductive urethane rubber, a resin layer and a rubber layer. The developing rollers 19Y, 19M, 19C and 19K are held in contact with the respective photosensitive members 3Y, 3M, 3C and 3K and driven to rotate counterclockwise as indicated by arrows in FIGS. 1 and 2.

Each of the toner charging units 20Y, 20M, 20C and 20K is formed by a corona charger, although the toner charging units 20Y, 20M, 20C and 20K may alternatively be formed by using other chargers. A toner charging bias is applied to each of the toner charging units 20Y, 20M, 20C and 20K to electrically charge the solid toner on the corresponding one of the developing rollers 19Y, 19M, 19C and 19K. The voltage applied to each of the toner charging units 20Y, 20M, 20C and 20K is defined to be a DC voltage, although a voltage formed by overlaying an AC voltage on a DC voltage may alternatively be applied. Regardless if the voltage applied to each of the toner charging units 20Y, 20M, 20C and 20K is a DC voltage or a voltage formed by overlaying an AC voltage on a DC voltage, it is defined to be higher than the discharge starting voltage at which an electric discharge starts between the toner charging unit 20Y, 20M, 20C or 20K and the corresponding developing roller 19Y, 19M, 19C or 19K, whichever appropriate, according to the Paschen's law.

As the developing rollers 19Y, 19M, 19C and 19K are electrically charged by the respective toner charging units 20Y, 20M, 20C and 20K, the solid toners in the liquid developers 23Y, 23M, 23C and 23K on the developing rollers 19Y, 19M, 19C and 19K are firmly applied onto the developing rollers 19Y, 19M, 19C and 19K respectively.

Each of the developing roller cleaning blades 21Y, 21M, 21C and 21K is typically formed by a piece of rubber, which is held in contact with the corresponding one of the developing rollers 19Y, 19M, 19C and 19K and adapted to scrape off and remove the developer remaining on the developing roller 19Y, 19M, 19C or 19K, whichever appropriate. Furthermore, reservoir sections 22Y, 22M, 22C and 22K of the liquid collected by the developing roller cleaners are containers for containing the liquid developers scraped from the developing rollers 19Y, 19M, 19C and 19K by the developing roller cleaning blades 21Y, 21M, 21C and 21K respectively.

The image forming apparatus 1 of this embodiment additionally has developer supply units 27Y, 27M, 27C and 27K for supplying liquid developers 23Y, 23M, 23C, 23K to the liquid developer containers 24Y, 24M, 24C and 24K respectively. Note that the developer supply units 27Y, 27M, 27C and 27K are shown only in FIG. 2 and omitted from FIG. 1.

The developer supply units 27Y, 27M, 27C and 27K respectively have toner tanks 28Y, 28M, 28C and 28K, carrier tanks 29Y, 29M, 29C and 29K and agitation units 30Y, 30M, 30C and 30K.

The toner tanks 28Y, 28M, 28C and 28K respectively contain liquid toners 31Y, 31M, 31C and 31K containing solid toners of the respective colors. The carrier tanks 29Y, 29M, 29C and 29K contain liquid carriers 32Y, 32M, 32C and 32K of the respective colors. The agitation units 30Y, 30M, 30C and 30K are respectively supplied with liquid toners 31Y, 31M, 31C and 31K from the toner tanks 28Y, 28M, 28C and 28K and liquid carriers 32Y, 32M, 32C and 32K from the carrier tanks 29Y, 29M, 29C and 29K by predetermined quantities.

The agitation units 30Y, 30M, 30C and 30K respectively prepare liquid developers 23Y, 23M, 23C and 23K to be used by the developing units 6Y, 6M, 6C and 6K by mixing and agitating the liquid toners 31Y, 31M, 31C and 31K and the liquid carriers 32Y, 32M, 32C and 32K supplied to them. The liquid developers 23Y, 23M, 23C and 23K respectively prepared by the agitation units 30Y, 30M, 30C and 30K are then supplied to the respective liquid developer containers 24Y, 24M, 24C and 24K.

The photosensitive member squeezing units 7Y, 7M, 7C and 7K respectively have squeezing rollers 33Y, 33M, 33C and 33K, squeezing roller cleaning blades 34Y, 34M, 34C and 34K and reservoir sections 35Y, 35M, 35C and 35K of the liquid collected by squeezing roller cleaners. The squeezing rollers 33Y, 33M, 33C and 33K are arranged respectively at the downstream sides relative to the contact sections (nip sections) of the photosensitive members 3Y, 3M, 3C and 3K and the developing rollers 19Y, 19M, 19C and 19K in the sense of rotation of the photosensitive members 3Y, 3M, 3C and 3K and at the upstream sides relative to the primary transfer units 8Y, 8M, 8C and 8K in the sense of rotation of the photosensitive members 3Y, 3M, 3C and 3K. They are driven to rotate in the opposite sense relative to the sense of rotation of the photosensitive members 3Y, 3M, 3C and 3K (counterclockwise in FIGS. 1 and 2) to remove the liquid carriers on the photosensitive members 3Y, 3M, 3C and 3K.

Each of the squeezing rollers 33Y, 33M, 33C and 33K is preferably prepared as an elastic roller that is formed by arranging an elastic member typically made of electro-conductive urethane rubber and a fluorine resin surface layer on the surface of a metal core. The squeezing roller cleaning blades 34Y, 34M, 34C and 34K are formed respectively by elastic members typically made of rubber and held in contact with the surfaces of the corresponding squeezing rollers 33Y, 33M, 33C and 33K to remove the liquid carriers 32Y, 32M 32C and 32K remaining on the squeezing rollers 33Y, 33M, 33C and 33K. Additionally, the reservoir sections 35Y, 35M, 35C and 35K of the liquid collected by the squeezing roller cleaners are tanks or some other containers for storing the liquid developers scraped off from the squeezing rollers 33Y, 33M, 33C and 33K by the squeezing roller cleaning blades 34Y, 34M, 34C and 34K respectively.

The primary transfer units 8Y, 8M, 8C and 8K respectively have backup rollers 36Y, 36M, 36C and 36K for primary transfers for holding the intermediate transfer belt 10 in contact with the photosensitive members 3Y, 3M, 3C and 3K. Typically a voltage of about −200V showing the polarity opposite to the polarity of the toner particles is applied to each of the backup rollers 36Y, 36M, 36C and 36K so as to primarily transfer the toner image (liquid developer image) of the corresponding color on the photosensitive member 3Y, 3M, 3C or 3K, whichever appropriate, onto the intermediate transfer belt 10.

The photosensitive member cleaners 9Y, 9M, 9C and 9K respectively have photosensitive member cleaning blades 37Y, 37M, 37C and 37K and reservoir sections 38Y, 38M, 38C and 38K of the liquid collected by photosensitive member cleaners. All the photosensitive member cleaning blades 37Y, 37M, 37C and 37K are elastic members typically made of rubber that are respectively held in contact with the surfaces of the corresponding photosensitive members 3Y, 3M, 3C and 3K to scrape off and remove the liquid carriers remaining on the photosensitive members 3Y, 3M, 3C and 3K. The reservoir sections 38Y, 38M, 38C and 38K of the liquid collected by the photosensitive member cleaners are containers that are typically tanks for storing the liquid carriers scraped off from the photosensitive members 3Y, 3M, 3C and 3K by the photosensitive member cleaning blades 37Y, 37M, 37C and 37K respectively.

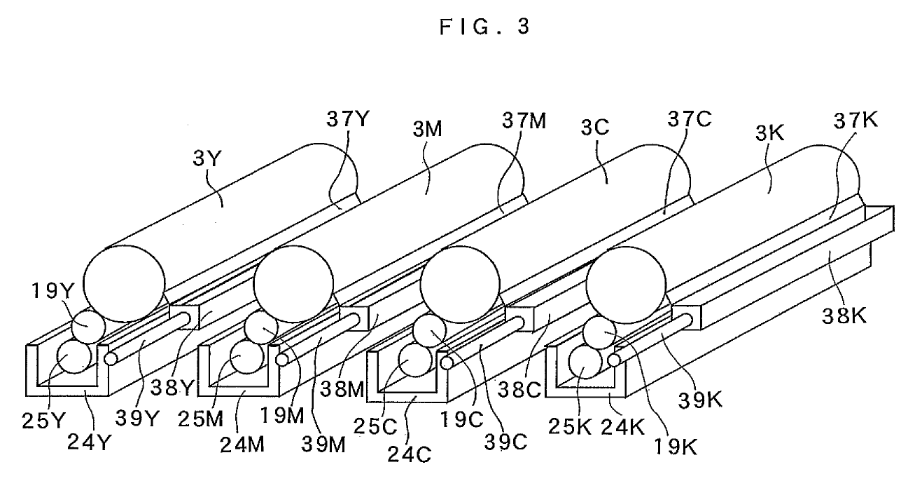

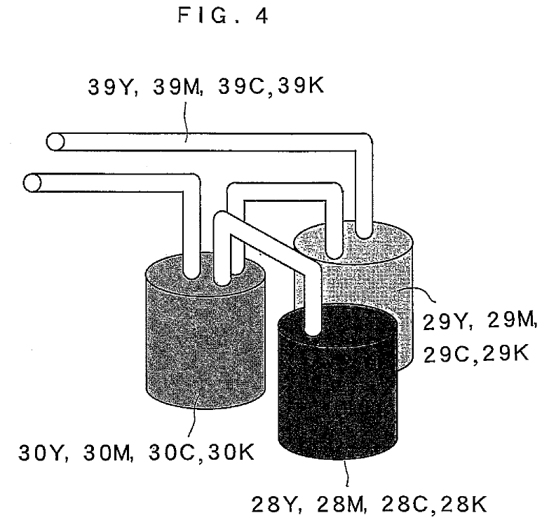

The liquid carriers stored in the reservoir sections 38Y, 38M, 38C and 38K of the liquid collected by the photosensitive member cleaners are then conveyed to the respective carrier tanks 29Y, 29M, 29C and 29K. At the time, the liquid carriers are conveyed by way of respective carrier conveying tubes 39Y, 39M, 39C and 39K shown in FIGS. 3 and 4. Additionally, the liquid developers stored in the reservoir sections 22Y, 22M, 22C and 22K of the liquid collected by the developing roller cleaners and the reservoir sections 35Y, 35M, 35C and 35K of the liquid collected by the squeezing roller cleaners are conveyed to the agitation units 30Y, 30M, 30C and 30K respectively.

The liquid developer collecting device of this embodiment of the present invention is formed by the photosensitive member squeezing units 7Y, 7M, 7C and 7K, the photosensitive member cleaners 9Y, 9M, 9C and 9K, the developing roller cleaning blades 21Y, 21M, 21C and 21K, the reservoir sections 22Y, 22M, 22C and 22K of the liquid collected by the developing roller cleaners developer supply units 27Y, 27M, 27C and 27K and the carrier conveying tubes 39Y, 39M, 39C and 39K.

Note that the liquid developers in the reservoir sections 22Y, 22M, 22C and 22K of the liquid collected by the developing roller cleaners and the reservoir sections 35Y, 35M, 35C and 35K of the liquid collected by the squeezing roller cleaners may alternatively be directly conveyed to the respective liquid developer containers 24Y, 24M, 24C and 24K.

The secondary transfer unit 15 has a secondary transfer roller 40. The secondary transfer roller 40 is arranged at the middle position between the belt drive roller 11 and the follower roller 12 and presses the intermediate transfer belt 10 wound around the belt drive roller 11 and the follower roller 12 in a direction perpendicular to it. The secondary transfer roller 40 forces the part of the intermediate transfer belt 10 between the belt drive roller 11 and the follower roller 12 to be brought into contact with a recording medium so that the color toner image (liquid developer image) formed by combining the toner images of the different colors on the intermediate transfer belt 10 is successfully transferred onto the recording medium as secondary transfer.

At this time, the recording medium conveyed to the secondary transfer unit 15 is brought into tight contact with the intermediate transfer belt 10 in the predetermined moving region of the recording medium extending from the belt drive roller 10 to the follower roller 12. As a result, the full color toner image on the intermediate transfer belt 10 is transferred onto the recording medium under the condition where the recording medium is held in tight contact with the intermediate transfer belt 10 for a predetermined period of time. Thus, the second transfer process is conducted successfully.

The fixing unit 16 has a pair of rollers including a heating roller 41 and a pressurizing roller 42. The heating roller 41 and the pressurizing roller 42 heat and pressurize the recording medium that proceeds between them and on which the full color toner image has been transferred so as to fix the toner image on the recording medium by means of heat and pressure.

Now, the image forming operation of the image forming apparatus 1 of this embodiment having the above-described configuration will be described below. The image forming apparatus 1 is controlled by a control unit (not shown) for image forming operations and other operations.

As an image forming operation is started, the photosensitive members 3Y, 3M, 3C and 3K are electrically uniformly charged by the respective charging units 4Y, 4M, 4C and 4K. Then, electrostatic latent images of the different colors are formed respectively on the photosensitive members 3Y, 3M, 3C and 3K by the respective exposure units 5Y, 5M, 5C and 5K.

Then, at the developing unit 6Y for yellow Y, the liquid developer 23Y of yellow Y adhering to the anilox roller 25Y is made to adhere only to the inside of the groove of the anilox roller. 25Y by the developer limiting blade 26Y by an appropriate quantity. The liquid developer 23Y in the groove of the anilox roller 25Y is then supplied to the developing roller 19Y. Additionally, the liquid developer 23Y on the developing roller 19Y is electrically charged by the toner charging unit 20Y. Under this condition, the liquid developer 23Y on the developing roller 19Y is conveyed toward the photosensitive member 2Y as the developing roller 19 is driven to rotate.

Thus, the electrostatic latent image formed on the photosensitive member 2Y of yellow Y is developed at the developing unit 6Y by the liquid developer 23Y of yellow Y so that a liquid developer image of yellow Y is formed on the photosensitive member 2Y. The liquid developer remaining on the developing roller 19Y after the completion of the developing process is scraped off from the developing roller 19Y by the developing roller cleaning blade 21Y and stored in the reservoir section 22Y of the liquid collected by the developing roller cleaner. Furthermore, the liquid developer in the reservoir section 22Y of the liquid collected by the developing roller cleaner is conveyed to the agitation unit 30Y for reutilization.

The liquid developer image of yellow Y on the photosensitive member 2Y is turned to a toner image of yellow Y as the liquid carrier 31Y on the photosensitive member 2Y is collected by the squeezing roller 33Y. Then, the toner image of yellow Y is transferred onto the intermediate transfer belt 10 by the primary transfer unit 8Y. The toner image of yellow Y on the intermediate transfer belt 10 is then conveyed toward the primary transfer unit 8M of magenta M.

The liquid carrier 31Y adhering to the squeezing roller 33Y is scraped off by the squeezing roller cleaning blade 34 and stored in the reservoir section 35Y of the liquid collected by the squeezing roller cleaner. Furthermore, the liquid developer in the reservoir section 35Y of the liquid collected by the squeezing roller cleaner is conveyed to the agitation unit 30Y for reutilization.

Additionally, the liquid developer 23Y remaining on the photosensitive member 3Y after the completion of the primary transfer is scraped off from the photosensitive member 3Y by the photosensitive member cleaning blade 37Y and stored in the reservoir section 38Y of the liquid collected by the photosensitive member cleaner. Furthermore, the liquid developer 23Y in the reservoir section 38Y of the liquid collected by the photosensitive member cleaner is conveyed to the carrier tank 29Y by way of the carrier conveying tube 39Y for reutilization.

Then, the electrostatic latent image formed on the photosensitive member 2M of magenta M is developed at the developing unit 6M by the liquid developer 23M of magenta M that has been conveyed as in the case of yellow Y so that a liquid developer image of magenta M is formed on the photosensitive member 2M. The liquid developer 23M remaining on the developing roller 19M after the completion of the developing process is removed from the developing roller 19M by the developing roller cleaning blade 21M and conveyed to the agitation unit 30M for reutilization.

The liquid developer image of magenta M on the photosensitive member 2M is turned to a toner image of magenta M as the liquid carrier 32M on the photosensitive member 2M is collected by the squeezing roller 33M. The toner image of magenta M is transferred onto the intermediate transfer belt 10 by the primary transfer unit 7M so as to be overlaid on the toner image of yellow Y by color registration.

The liquid developer 23M adhering to the squeezing roller 33M is removed from the squeezing roller 33M by the squeezing roller cleaning blade 34M and conveyed to the agitation unit 30M as in the above-described case of yellow Y for reutilization. Additionally, the liquid developer 23M of magenta M remaining on the photosensitive member 3M after the completion of the primary transfer is scraped off from the photosensitive member 3M by the photosensitive member cleaning blade 37M and stored in the reservoir section 38M of the liquid collected by the photosensitive member cleaner. Furthermore, the liquid developer 23M in the reservoir section 38M of the liquid collected by the photosensitive member cleaner conveyed to the carrier tank 29M by way of the carrier conveying tube 39M for reutilization.

The toner images of yellow Y and magenta M that are laid one on the other by color registration is then conveyed toward the primary transfer unit 7C of cyan C. Thus, the toner image of cyan C and that of black K are sequentially overlaid on the toner images of yellow Y and magenta M on the intermediate transfer belt 10 by color registration in a similar manner to produce a full color toner image on the intermediate transfer belt 10.

Then, as in the above-described case of yellow Y and magenta M, the liquid developers 23C and 23K remaining on the developing rollers 19C and 19K are removed respectively from the developing rollers 19C and 19K by the developing roller cleaning blades 21C and 21K and conveyed to the agitation units 30C and 30K for reutilization. Additionally, the liquid developers 23C and 23K adhering respectively to the squeezing rollers 33C and 33K are removed from the squeezing rollers 33C and 33K by the squeezing roller cleaning blades 34C and 34K and conveyed to the agitation units 30C and 30K for reutilization.

Still additionally, the liquid developers 23C and 23K of cyan and black remaining on the photosensitive members 3C and 3K after the completion of the primary transfers are respectively scraped off from the photosensitive members 3C and 3K by the photosensitive member cleaning blades 37C and 37K and stored in the reservoir sections 38C and 38K of the liquid collected by the photosensitive member cleaners. Furthermore, the liquid developers 23C and 23M in the reservoir sections 38C and 38K of the liquid collected by the photosensitive member cleaners are respectively conveyed to the carrier tanks 29C and 29K by way of the carrier conveying tubes 39C and 39K for reutilization.

Thereafter, the color toner image on the intermediate transfer belt 10 is transferred onto the transfer surface of the recording medium by the secondary transfer unit 15 as secondary transfer. At this time, the recording medium conveyed to the secondary transfer unit 15 is brought into tight contact with the intermediate transfer belt 10 within the range extending from the belt drive roller 11 to the follower roller 12 by the secondary transfer roller 40. As a result, the full color toner image on the intermediate transfer belt 10 is secondarily transferred onto the recording medium under the condition where the recording medium is held in tight contact with the intermediate transfer belt 10 for a predetermined period of time. Thus, the second transfer process is conducted successfully. At this time, the intermediate transfer belt 10 is warped inwardly at the nip position by the secondary transfer roller 40 so that the recording medium that has passed the nip position is urged toward the intermediate transfer belt 10. Thus, the recording medium that has passed the nip position is effectively brought into tight contact with the intermediate transfer belt 10. Thus, as a result, the second transfer process is conducted more successfully.

The color toner image transferred onto the recording medium is then pressurized, heated and fixed by the fixing unit 16. Then, the recording medium on which the fixed full color image is formed is conveyed to the delivery tray to end the color image forming operation.

Meanwhile, in the image forming apparatus 1 that employs liquid developers 23Y, 23M, 23C and 23K, the liquid developers 23Y, 23M, 23C and 23K remaining on the developing rollers 19Y, 19M, 19C and 19K, the liquid developers 23Y, 23M, 23C and 23K adhering to the squeezing rollers 33Y, 33M, 33C and 33K and the liquid developers 23Y, 23M, 23C and 23K remaining on the photosensitive members 3Y, 3M, 3C and 3K respectively are reutilized.

Therefore, the electric charges of the toners that are being reutilized on the developing rollers 19Y, 19M, 19C and 19K are not stable. Particularly, when the developing rollers 19Y, 19M, 19C and 19K are constantly held in contact with the respective photosensitive members 3Y, 3M, 3C and 3K, the toners move to the photosensitive members 3Y, 3M, 3C and 3K respectively to give rise to a problem that the image concentration may become instable. Additionally, there may arise a color mixing problem that the liquid developers 23Y, 23M, 23C and 23K of the different colors may be mixed with liquid developers 23Y, 23M, 23C and 23K of different colors.

In view of these problem, the developing method and the image forming method of this embodiment are made to have the following steps.

The developing method of this embodiment includes at least a step of driving the photosensitive members 3Y, 3M, 3C and 3K to rotate, a step of driving the developing rollers 19Y, 19M, 19C and 19K of the developing units 4Y, 4M, 4C and 4K to rotate in a state where they are separated from the photosensitive members 3Y, 3M, 3C and 3K, a step of supplying liquid developers 23Y, 23M, 23C and 23K respectively from the liquid developer containers 24Y, 24M, 24C and 24K to the developing rollers 19Y, 19M, 19C and 19K, a step of applying a toner charging bias to the toner charging units 20Y, 20M, 20C and 20K and electrically charging the liquid developers 23Y, 23M, 23C and 23K on the developing rollers 19Y, 19M, 19C and 19K by the toner charging units 20Y, 20M, 20C and 20K respectively, a step of bringing the developing rollers 19Y, 19M, 19C and 19K into contact with the photosensitive members 3Y, 3M, 3C and 3K to develop the electrostatic latent images after the charged toners on the developing rollers 19Y, 19M, 19C and 19K pass through the contact positions (developing positions) where the photosensitive members 3Y, 3M, 3C and 3K contact the developing rollers 19Y, 19M, 19C and 19K respectively due to the rotations of the developing rollers 19Y, 19M, 19C and 19K, a step of separating the developing rollers 19Y, 19M, 19C and 19K from the photosensitive members 3Y, 3M, 3C and 3K respectively after the end of the developing operations, a step of stopping the application of the toner charging bias to the toner charging units 20Y, 20M, 20C and 20K after the developing rollers 19Y, 19M, 19C and 19K are separated from the photosensitive members 3Y, 3M, 3C and 3K respectively, a liquid developer collecting step of collecting the remaining liquid developers 23Y, 23M, 23C and 23K on the respective photosensitive members 3Y, 3M, 3C and 3K after the transfers of the toner images, a step of stopping the rotations of the developing rollers 19Y, 19M, 19C and 19K after stopping the application of the toner charging bias to the toner charging units 20Y, 20M, 20C and 20K and a step of stopping the rotations of the photosensitive members 3Y, 3M, 3C and 3K after stopping the application of the toner charging bias to the toner charging units 20Y, 20M, 20C and 20K.

The image forming method of this embodiment includes at least a developing step using the above-described developing method, a transfer step of transferring the toner images on the photosensitive members 3Y, 3M, 3C and 3K onto the intermediate transfer belt 10 and a step of stopping the rotations of the developing rollers 19Y, 19M, 19C and 19K and those of the photosensitive members 3Y, 3M, 3C and 3K after the transfers of the toner images on the photosensitive members 3Y, 3M, 3C and 3K onto the intermediate transfer belt 10.

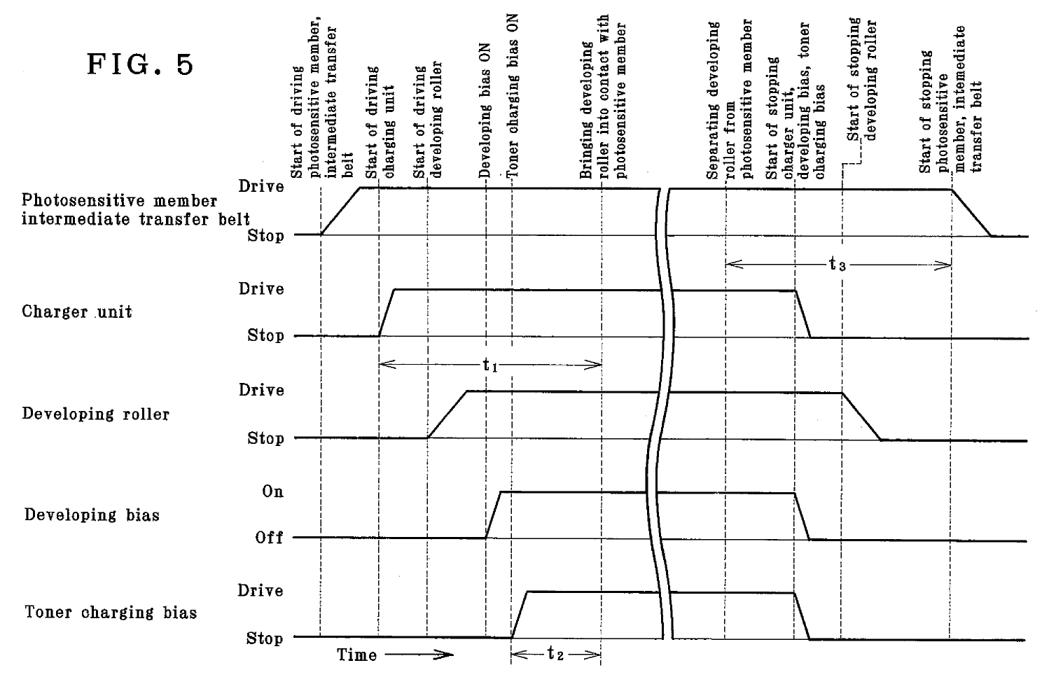

Additionally, when the image forming apparatus 1 of this embodiment employs the developing method and the image forming method, it controls the printing operation by sequence control as shown in FIG. 5, using the control unit thereof, so provide a good image concentration and prevent color mixing from taking place. When the image forming apparatus 1 is not operating, the developing units 6Y, 6M, 6C and 6K are separated from the respective photosensitive members 3Y, 3M, 3C and 3K. As a printing command is issued as shown in FIG. 5, the photosensitive members 3Y, 3M, 3C and 3K and the intermediate transfer belt 10 begin to be driven to rotate. When the photosensitive members 3Y, 3M, 3C and 3K and the intermediate transfer belt 10 rotate in a steady state and hence get to respective constant rates of rotations that are set for the image forming operation, the charging units 4Y, 4M, 4C and 4K begin to be driven to operate. As a result, the photosensitive members 3Y, 3M, 3C and 3K start to be electrically charged.

After the photosensitive members 3Y, 3M, 3C and 3K are uniformly charged, the developing rollers 19Y, 19M, 19C and 19K start to be driven to rotate. When the developing rollers 19Y, 19M, 19C and 19K rotate in a steady state, the developing biases are turned on and applied to the developing rollers 19Y, 19M, 19C and 19K. The toner charging biases are turned on by the toner charging units 20Y, 20M, 20C and 20K after the developing biases of the developing rollers 19Y, 19M, 19C and 19K get to a steady state. Then, the toners on the developing rollers 19Y, 19M, 19C and 19K begin to be electrically charged. The developing rollers 19Y, 19M, 19C and 19K are brought into contact with the respective photosensitive members 3Y, 3M, 3C and 3K when a predetermined time period t₁sec passes from the start of driving the charging units 4Y, 4M, 4C and 4K and another predetermined time period t₂sec passes from the start of driving the toner charging units 20Y, 20M, 20C and 20K after the toner charging biases of the toner charging units 20Y, 20M, 20C and 20K get to a maximum peak value and hence a steady state, that is after the toner charging biases get to the value preset for electrically charging toners. The predetermined time period t₂sec is defined to be the time until charged toners on the developing rollers 19Y, 19M, 19C and 19K pass the respective contact positions (the nip positions, or the developing positions) of the developing rollers 19Y, 19M, 19C and 19K and the photosensitive members 3Y, 3M, 3C and 3K. Thus, the developing rollers 19Y, 19M, 19C and 19K are respectively brought into contact with the photosensitive members 3Y, 3M, 3C and 3K after the charged toners on the developing rollers 19Y, 19M, 19C and 19K pass the contact positions (nip positions, or the developing positions) of the developing rollers 19Y, 19M, 19C and 19K and the photosensitive members 3Y, 3M, 3C and 3K. Then, as a result, the electrostatic latent images on the photosensitive members 3Y, 3M, 3C and 3K are developed. Subsequently, the operation of forming a toner image on a recording medium is carried out in a manner as described above.

As the process of developing the electrostatic latent images by the developing rollers 19Y, 19M, 19C and 19K ends, the developing units 6Y, 6M, 6C and 6K are separated from the respective photosensitive members 3Y, 3M, 3C and 3K. Thereafter, the process of stopping the operation of the charging units 4Y, 4M, 4C and 4K, that of stopping the application of the developing biases to the developing rollers 19Y, 19M, 19C and 19K and that of stopping the application of the toner charging biases by the toner charging units 20Y, 20M, 20C and 20K are started. The process of stopping driving the developing rollers 19Y, 19M, 19C and 19K starts after the charging units 4Y, 4M, 4C and 4K, the application of the developing biases and the toner charging units 20Y, 20M, 20C and 20K are completely stopped. Subsequently, both the process of stopping driving the photosensitive members 3Y, 3M, 3C and 3K and that of stopping the intermediate transfer belt 10 are started after the elapse of time of t₃sec from the separation of the developing units 6Y, 6M, 6C and 6K from the photosensitive members 3Y, 3M, 3C and 3K. Then, the image forming apparatus 1 goes out of operation as the photosensitive members 3Y, 3M, 3C and 3K and the intermediate transfer belt 10 are completely stopped.

In this way, in the image forming apparatus 1 of this embodiment, the photosensitive members 3Y, 3M, 3C and 3K, charging units 4Y, 4M, 4C and 4K and the developing rollers 19Y, 19M, 19C and 19K begin to be driven to operate in a state where the developing units 6Y, 6M, 6C and 6K are separated from the respective photosensitive members 3Y, 3M, 3C and 3K when starting a printing operation. The application of the toner biases by the toner charging units 20Y, 20M, 20C and 20K is started and the toners on the developing rollers 19Y, 19M, 19C and 19K are electrically charged according to the state of rotation of the developing rollers 19Y, 19M, 19C and 19K. After the toners on the developing rollers 19Y, 19M, 19C and 19K are electrically charged, the developing rollers 19Y, 19M, 19C and 19K are brought into contact with the respective photosensitive members 3Y, 3M, 3C and 3K. In this way, the electrostatic latent images on the photosensitive members 3Y, 3M, 3C and 3K are developed by the respective toners on the developing rollers 19Y, 19M, 19C and 19K.

After the end of the printing operation, the developing units 6Y, 6M, 6C and 6K are separated respectively from the photosensitive members 3Y, 3M, 3C and 3K while the photosensitive members 3Y, 3M, 3C and 3K and the developing rollers 19Y, 19M, 19C and 19K are still rotating. After the charging units 4Y, 4M, 4C and 4K, the developing biases and the toner charging biases by the toner charging units 20Y, 20M, 20C and 20K are completely stopped and when time t₃sec passes from the separation of the developing units 6Y, 6M, 6C and 6K from the respective photosensitive members 3Y, 3M, 3C and 3K, the process of stopping driving the photosensitive members 3Y, 3M, 3C and 3K and that of stopping the intermediate transfer belt 10 are started. The time period of t₃sec is defined to be the time until at least when the process of transferring the toner image on the intermediate belt 10 to the recording medium to the last part thereof ends as secondary transfer. Note that the time period t₃sec is more preferably defined to be the time until the part of the intermediate transfer belt 10 bearing the last part of the toner image transferred onto it by secondary transfer completely passes the intermediate transfer belt cleaning blade 17.

Thus, with the image forming apparatus 1 of this embodiment, the liquid developers 31Y, 31M, 31C and 31K remaining on the respective photosensitive members 3Y, 3M, 3C and 3K after the primary transfer are removed by the photosensitive member cleaners 9Y, 9M, 9C and 9K and collected by the developer supply units 27Y, 27M, 27C and 27K for reutilization.

The developing rollers 19Y, 19M, 19C and 19K of the different colors are held in a state of being separated from the respective corresponding photosensitive members 3Y, 3M, 3C and 3K before the start of the developing process by sequence control. Then, the photosensitive members 3Y, 3M, 3C and 3K and the developing rollers 19Y, 19M, 19C and 19K are driven to rotate at the time of the start of the developing process under this condition and the toner charging biases are applied respectively to the toner charging units 20Y, 20M, 20C and 20K and the solid toners in the liquid developers 31Y, 31M, 31C and 31R on the developing rollers 19Y, 19M, 19C and 19K are electrically charged by the toner charging units 20Y, 20M, 20C and 20K. Then, the developing rollers 19Y, 19M, 19C and 19K are brought into contact with the respective photosensitive members 3Y, 3M, 3C and 3K in a state where the developing rollers 19Y, 19M, 19C and 19K and the photosensitive members 3Y, 3M 3C and 3K are driven to rotate and the solid toners on the developing rollers 19Y, 19M, 19C and 19K are electrically charged. Thus, the toners on the developing rollers 19Y, 19M, 19C and 19K are respectively transferred onto the photosensitive members 3Y, 3M, 3C and 3K by the developing biases in a state where the toners on the developing rollers 19Y, 19M, 19C and 19K are reliably electrically charged. As a result, the electrostatic latent images on the respective photosensitive members 3Y, 3M, 3C and 3K are developed and corresponding toner images are formed on the photosensitive members 3Y, 3M, 3C and 3K. Furthermore, the toner images on the photosensitive members 3Y, 3M, 3C and 3K are transferred on the intermediate transfer belt 10 by the transfer bias. Thus, a toner image is formed on the intermediate transfer belt 10.

Now, the electrically charged toners are controlled by developing biases and transfer biases. Therefore, any of the toners or the toner on the intermediate transfer belt 10 is prevented from being moved, if partly, to the next photosensitive member of a different color. As a result, if the residual liquid developers 31Y, 31M, 31C and 31K collected from the respective photosensitive members 3Y, 3M, 3C and 3K after the primary transfer operation are reutilized, color mixing of toners at the time of starting a printing operation can be effectively prevented from taking place.

Additionally, after the end of the developing process, the developing rollers 19Y, 19M, 19C and 19K are separated from the respective photosensitive members 3Y, 3M, 3C and 3K in a state where the photosensitive members 3Y, 3M, 3C and 3K and the developing rollers 19Y, 19M, 19C and 19K are rotating. Then, the application of the toner charging biases to the respective toner charging units 20Y, 20M, 20C and 20K is stopped in a state where the developing rollers 19Y, 19M, 19C and 19K are separated from the photosensitive members 3Y, 3M, 3C and 3K. Thereafter, both the rotations of the developing rollers 19Y, 19M, 19C and 19K and those of the photosensitive members 3Y, 3M, 3C and 3K are stopped. Therefore, both the rotations of the photosensitive members 3Y, 3M, 3C and 3K and those of the developing rollers 19Y, 19M, 19C and 19K are stopped in a state where the liquid developers 31Y, 31M, 31C and 31K would not be transferred respectively from the developing rollers 19Y, 19M, 19C and 19K to the photosensitive members 3Y, 3M, 3C and 3K. As a result, color mixing of toners of different colors is suppressed to further effectively prevent color mixing of toners from taking place.

More preferably, after the end of the developing process, both the rotations of the developing rollers 19Y, 19M, 19C and 19K and those of the photosensitive members 3Y, 3M, 3C and 3K can be stopped after the black (K) liquid developer, which is the last liquid developer on the intermediate transfer belt 10, which bears the last liquid developers 31Y, 31M, 31C and 31K, passes the primary transfer unit 8K. With such an arrangement, after the primary transfer, any of the toners of the other colors on the intermediate transfer belt 10 is prevented from being transferred onto any of the photosensitive members of the other colors to consequently suppress color mixing of toners of different colors. Thus, color mixing of toners is further effectively prevented from taking place.

More preferably, after the end of the developing process, both the rotations of the developing rollers 19Y, 19M, 19C and 19K and those of the photosensitive members 3Y, 3M, 3C and 3K can be stopped after the last liquid developers 31Y, 31M, 31C and 31K on the intermediate transfer belt 10 pass the secondary transfer unit 15. More preferably, after the end of the developing process, both the rotations of the developing rollers 19Y, 19M, 19C and 19K and those of the photosensitive members 3Y, 3M, 3C and 3K can be stopped after the last liquid developers 31Y, 31M, 31C and 31K on the intermediate transfer belt 10 pass the intermediate transfer belt cleaning blade 17 of the intermediate transfer belt cleaning unit. With such an arrangement, after the primary transfer, any of the toners of the other colors on the intermediate transfer belt 10 is further prevented from being transferred onto any of the photosensitive members of the other colors to consequently suppress color mixing of toners of different colors. Thus, color mixing of toners is further effectively prevented from taking place.

Now, the image forming apparatus 1 of this embodiment that is adapted to prevent color mixing will be described further by way of Examples 1 through 3.

### Items Common to Examples 1 through 3

Firstly, the items that are common to the image forming apparatus of Examples 1 through 3 will be described below. All the image forming apparatus of Examples 1 through 3 are those where the image forming sections of yellow Y, magenta M, cyan C and black K as shown in FIGS. 1 and 2 are arranged is random along the moving direction β of the transferring side of the intermediate transfer belt 10 in the mentioned order.

The diameter of the photosensitive members and the distance relationships of the components arranged around the photosensitive members are listed in Table 1 below.

TABLE 1

| | | time necessary to move |
|---|---|---|
| photosensitive member diameter | ø78 mm | |
| distance between charging and | 52.4 mm | 0.25 sec |
| developing | | |
| distance between developing and | 86.9 mm | 0.41 sec |
| primary transfer | | |

As shown in Table 1, the diameter of the photosensitive members of the four colors is φ78 mm. The distance between the charging position and the developing position (the distance between the center of the photosensitive member charging position and the center of the nip position of the developing roller to the photosensitive member) is 52.4 mm. The distance between the developing position and the primary transfer position (the distance between the center of the nip position of the developing roller to the photosensitive member and the center of the nip position of the photosensitive member to the intermediate transfer belt 10) is 86.9 mm. The moving speeds of the outer peripheries of all the photosensitive members, the developing rollers and the intermediate transfer belt are uniformly 214 mm/sec. Therefore, the time required for each of the photosensitive members to move from the charging position to the developing position is 0.25 seconds, while the time required for each of the photosensitive members to move from the developing position to the primary transfer position is 0.41 seconds.

The diameter of the developing rollers and the distance relationship of the components arranged around the developing rollers are listed in Table 2 below.

TABLE 2

| | | time necessary to move |
|---|---|---|
| developing roller diameter | ø32 mm | |
| distance between toner charging | 26.3 mm | 0.12 sec |
| and developing | | |

As shown in Table 2, the diameter of the developing rollers of the four colors is φ32 mm. The distance between the toner charging position and the developing position (the distance between the center of the toner charging position on the developing roller and the center of the nip position of the developing roller to the photosensitive member) is 26.3 mm. Thus, the time required for each of the developing rollers to move from the toner charging position to the developing position is 0.12 seconds.

Now, the distance relationships of the components arranged around the intermediate transfer belt are listed in Table 3 below.

TABLE 3

| | | time necessary |
|---|---|---|
| | | to move |
| distance between primary transfer of | 600 mm | 2.80 sec |
| first color and primary transfer | | |
| of fourth color | | |
| distance between primary transfer of | 750 mm | 3.50 sec |
| first color and secondary transfer | | |
| distance between primary transfer of | 1,650 mm | 7.71 sec |
| first color and intermediate | | |
| transfer cleaning | | |

As shown in Table 3, the distance between the primary transfer position of the first color (yellow) and the primary transfer position of the fourth color (black) is 600 mm. The distance between the primary transfer position of the first color (yellow) and the secondary transfer position is 750 mm. The distance between the primary transfer position of the first color (yellow) and the intermediate transfer belt cleaning position is 1,650 mm. The time required for the intermediate transfer belt to move from the primary transfer position of the first color to the primary transfer position of the fourth color is 2.80 seconds. The time required for the intermediate transfer belt to move from the primary transfer position of the first color to the secondary transfer position is 3.50 seconds. The time required for the intermediate transfer belt to move from the primary transfer position of the first color to the intermediate transfer belt cleaning position is 7.71 seconds.

The image forming apparatus is driven for a printing operation according to the sequence illustrated in FIG. 5. When the image forming apparatus is driven to start operating, a steady state where a toner charging bias is applied to the toners on the rotating developing rollers and the toners on the developing rollers are electrically charged is in place. The photosensitive members are already driven to rotate when the developing rollers are brought into contact with the corresponding respective photosensitive members with the above sequence. Therefore, the surface potentials at the developing positions on the surfaces of the photosensitive members are already brought into the predetermined potential by the respective charging units.

Table 4 below shows the operation timings of the components. The time when the developing rollers come to contact with the respective photosensitive members is selected as reference timing of 0 sec.

TABLE 4

| | |
|---|---|
| start of driving photosensitive members, transfer belt | −0.50 sec |
| charging (wires and grids) ON | −0.30 sec |
| driving developing rollers | −0.25 sec |
| developing biases ON | −0.20 sec |
| toner charging biases ON | −0.15 sec |

As shown in Table 4, the photosensitive members and the intermediate transfer belt start to be driven to rotate at −0.50 sec in FIG. 5. In other words, the timing of the start of driving the photosensitive members and the intermediate transfer belt is defined to be 0.50 sec prior to the timing of bringing the developing rollers into contact with the respective photosensitive members. The timing of the start of driving the charging units is −0.30 sec.

In other words, it is defined to be 0.3 sec prior to the timing of bringing the developing rollers into contact with the respective photosensitive members. The timing of the start of driving the developing rollers is −0.25 sec. In other words, it is defined to be 0.25 sec prior to the timing of bringing the developing rollers into contact with the respective photosensitive members. The timing of the start of electrically charging the toners is −0.15 sec. In other words, it is defined to be 0.15 sec prior to the timing of bringing the developing rollers into contact with the respective photosensitive members.

The reasons of selecting the timings of operations of the components as shown in Table 4 will be described below.

A time duration of 0.25 sec is required for the electrically charged part of each of the photosensitive members to get to the developing position (the contact position of the corresponding developing roller and the photosensitive member, which is the developing position) when the developing roller comes to contact with the photosensitive member as shown in Table 1. Therefore, in this Example, 0.3 sec is selected from the time when the corresponding charging unit starts to be driven to the time when the developing roller comes to contact with the photosensitive member with a safety margin for allowing the electrically charged part of the photosensitive member to reliably get to the developing position. In other words, 0.3 sec is selected for time t₁ in FIG. 5 in Example 1 as well as in Examples 2 and 3.

When the charging bias is applied, the photosensitive member needs to be already rotating in a steady state (with a peripheral speed of 214 mm/sec). If the charging bias is turned on before the peripheral speed of the photosensitive member gets to the steady-state rotation of 214 mm/sec, the charged potential of the photosensitive member can become unnecessarily high. Then, problems such as a leak current can undesirably take place. The high voltage source requires a rising time of about 0.01 sec before it starts to operate properly and the photosensitive member requires about 0.05 to 0.10 sec before it starts to rotate in a steady state. Taking these into consideration, the timing of starting driving the photosensitive member to rotate is selected to be 0.20 sec earlier than the timing of starting driving the corresponding charging unit to operate. However, it should be noted that the peripheral speed of the photosensitive member should already get to the predetermined speed (peripheral speed of 214 mm/sec) the moment when the charging bias gets to the peak as minimum requirement to be met.

On the other hand, a time of 0.12 sec is required for the toner on the developing roller that is electrically charged by the corresponding toner charging unit to get to the developing position at the time when the developing roller comes to contact with the photosensitive member as shown in Table 2. Therefore, in this example, 0.15 sec, which is longer than 0.12 sec, is selected from the time when the toner charging unit starts to be driven to operate to the time when the developing roller comes to contact with the photosensitive member with a safety margin for allowing the electrically charged part of the photosensitive member to reliably get to the developing position. In other words, 0.15 sec is selected for time t₂ in FIG. 5 in Example 1 as well as in Examples 2 and 3.

Additionally, the developing roller needs to be rotating in a steady state and the developing bias needs to be on when the process of charging the toner starts. If the developing roller is not rotating yet or rotating at a speed lower than the speed in the steady state, the toner is charged to an excessively high level, which can undesirably give rise to problems in some of the subsequent processes including the developing process and the transfer process.

Still additionally, when the process of charging the toner is turned on in a state where the developing bias is still of f, the quantity of the electric charge (ions) that is generated and applied to the toner becomes instable and cannot remain the same until the time when the developing bias is turned on. Therefore, the start of driving the developing roller to rotate and the operation of turning on the developing bias need to take place prior to the process of electrically charging the toner.

The start of driving the developing roller to rotate may take place before the start of the operation of turning on the developing bias or vice versa. In Examples 1 through 3, the start of driving the developing roller to rotate is made to take place before the start of the operation of turning on the developing bias. The timings of the components are selected as shown in Table 4, taking the rising time of the high voltage source and that of the operation of driving the developing roller to rotate into consideration.

On the other hand, for the end of the printing operation, both the timing of stopping the photosensitive members and the timing of stopping the intermediate transfer belt are so selected as to come after the developing rollers and the respective photosensitive members are separated from each other and the liquid toner of the first color passes the primary transfer position of the toner image of the fourth color. Liquid toners exist on the photosensitive members and the intermediate transfer belt after the developing rollers are separated from the photosensitive members. The liquid toners contain not only liquid carriers but also solid toner particles and hence the solid toner particles need to be prevented from giving rise to a problem of color mixing. According to the above-described arrangement, color mixing is prevented from taking place by stopping the operation of driving the photosensitive members and the intermediate transfer belt after the liquid toner existing on the photosensitive member of the first color is transferred onto the intermediate transfer belt and the intermediate transfer belt passes the primary transfer position of the fourth color.

Table 5 shows specific timings of the components at the end of the printing operation. In Table 5, the time when the developing rollers are separated from the respective photosensitive members is selected as reference timing of 0 sec.

TABLE 5

| | |
|---|---|
| stop of driving photosensitive members, transfer belt | 4.5 sec |
| charging (wires and grids) OFF | 0.10 sec |
| stop driving developing rollers | 0.25 sec |
| developing biases OFF | 0.10 sec |
| toner charging biases OFF | 0.10 sec |

As shown in Table 5, the timing of starting the process of stopping driving the photosensitive members and the intermediate transfer belt comes at time t₃sec in Table 5. The time of t₃sec differs from example to example in the case of Examples 1 through 3. The specific values of the time t₃sec in Examples 1 through 3 will be described hereinafter.

The timing of starting the process of stopping driving the charging units comes at 0.10 sec after the reference time. The timing of separating the developing rollers from the respective photosensitive members is defined to be at 0.10 sec after the reference time. Additionally, the timing of starting the process of stopping driving the developing rollers comes at 0.25 sec after the reference time, which is 0.25 sec after the timing of separating the developing rollers from the respective photosensitive members. Still additionally, the timing of starting the process of stopping the application of the developing biases comes 0.10 sec after the reference time, or 0.10 sec after the timing of bringing the developing rollers into contact with the respective photosensitive members. Furthermore, the timing of stopping the process of charging the toners comes at 0.10 sec after the timing of separating the developing rollers from the respective photosensitive members.

Now, the items specific to each of Examples 1 through 3 will be described below.

### Example 1

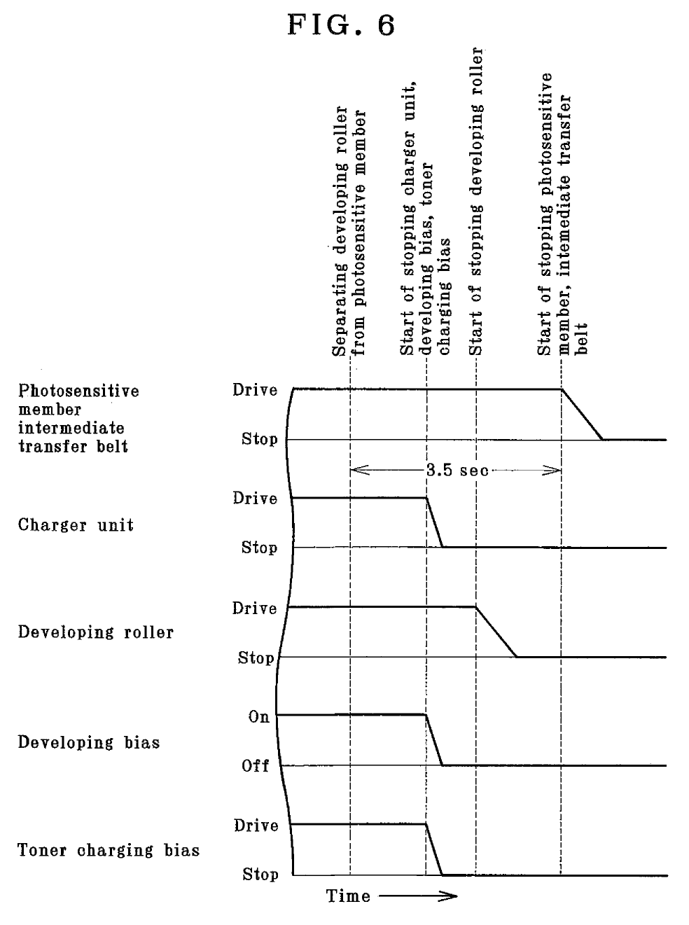

In Example 1, 3.5 sec is selected for the timing t₃sec of starting the process of stopping driving the photosensitive members and the intermediate transfer belt as shown in FIG. 6. The time required for the liquid toner existing on the photosensitive member of the first color to get to the primary transfer position of the fourth color is 3.21 sec from Tables 1 and 3. Thus, in this Example 1, the process of stopping driving the photosensitive members and the intermediate transfer belt is started 3.5 sec after the timing of separation of the developing rollers from the respective photosensitive numbers with a safety margin.

The timing of turning off the charging biases and hence stopping driving the charging units is made to come 0.10 sec after the separation of the developing rollers from the respective photosensitive members. More rigorously, the charging biases may be turned off any time after 0.25 sec prior to the timing of separation of the developing rollers from the respective photosensitive members. Since the rising time of the high voltage source is about 0.10 sec, the charging biases may be turned off anytime before about 0.1 sec prior to the timing when the photosensitive members are stopped.

Additionally, the toner charging biases and the developing biases may be turned off anytime after 0.12 sec prior to the timing of separation of the developing rollers from the respective photosensitive members. Thus, the toner charging biases and the developing biases are made to be turned off 0.10 sec after the timing of separation of the developing rollers from the respective photosensitive members in Example 1. Additionally, 0.25 sec is selected for the timing of stopping driving the developing rollers, considering the rising time of the high voltage output because the high voltage output is reliably off at that time after the separation of the developing rollers from the respective photosensitive members.

With the sequence of Example 1, the toners on the developing rollers are electrically charged before they respectively get to the developing nip sections at the time of starting the developing process and then move to the primary transfer nip sections and the secondary transfer nip section under a reliably charged condition. Therefore, the toners are reliably controlled respectively by the developing biases, the primary transfer biases and the secondary transfer bias. Thus, as a result, color mixing is effectively prevented from taking place.

The photosensitive members, the developing rollers and the intermediate transfer belt are stopped after the last toner on the photosensitive member 3Y of the first color, or yellow Y, is transferred onto the intermediate transfer belt 10 and the toner (which is the last toner now on the intermediate transfer belt 10) passes the primary transfer nip section of the fourth color, or black K. Thus, as a result, the toners are reliably transferred from the photosensitive members 3Y, 3M, 3C and 3K of the different colors onto the intermediate transfer belt 10 so that the toners remaining on the photosensitive members 3Y, 3M, 3C and 3K and the developing rollers 19Y, 19M, 19C and 19K are suppressed. Additionally, the toners remaining on the intermediate transfer belt 10 are removed by the intermediate transfer belt cleaning blade 17 before the toner of the first color gets to the primary transfer nip section in the next printing operation. Therefore, color mixing can be effectively prevented from taking place if the next printing operation is conducted after the elapse of some time from the last printing operation.

### Example 2

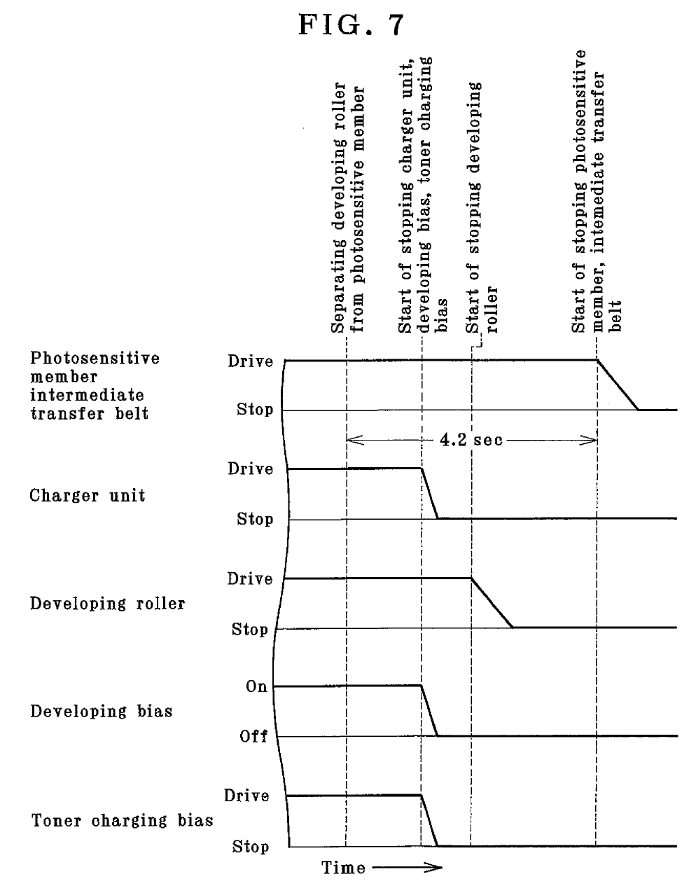

In Example 2, 4.2 sec is selected for the timing t₃sec of starting the process of stopping driving the photosensitive members and the intermediate transfer belt as shown in FIG. 7. The time required for the liquid toner existing on the photosensitive member of the first color to pass the secondary transfer position is 3.91 sec from Tables 1 and 3. Thus, in this Example 2, the process of stopping driving the photosensitive members and the intermediate transfer belt is started 4.2 sec after the timing of separation of the developing rollers from the respective photosensitive numbers with a safety margin. Otherwise, Example 2 is same as Example 1.

In the case of Example 2, the operation of driving the image forming apparatus can be stopped after the liquid toner existing on the photosensitive member of the first color passes the secondary transfer position. As a result, the toners on the intermediate transfer belt of the last printing operation whose electric charges have been attenuated are removed by the intermediate transfer belt cleaning blade 17 when the next printing operation is started so that the secondary transfer rollers are prevented from being contaminated by the toners whose electric charges have been attenuated.

Thus, color mixing can be more effectively prevented from taking place in Example 2 than in Example 1.

### Example 3

In Example 3, 8.6 sec is selected for the timing t₃sec of starting the process of stopping driving the photosensitive members and the intermediate transfer belt as shown in FIG. 7. The time required for the liquid toner existing on the photosensitive member of the first color to pass the intermediate transfer belt cleaning blade 17 is 8.32 sec from Tables 1 and 3. Thus, in this Example 3, the process of stopping driving the photosensitive members and the intermediate transfer belt is started 8.6 sec after the timing of separation of the developing rollers from the respective photosensitive numbers with a safety margin.

In the case of Example 3, the operation of driving the image forming apparatus can be stopped after the liquid toner existing on the photosensitive member of the first color passes the intermediate transfer belt cleaning position. As a result, solid toner particles and the liquid carrier on the intermediate transfer belt are prevented from being carried by the intermediate transfer belt and getting into various processes to contaminate the members relating to such processes.

Thus, color mixing can be more effectively prevented from taking place in Example 3 than in Example 2.

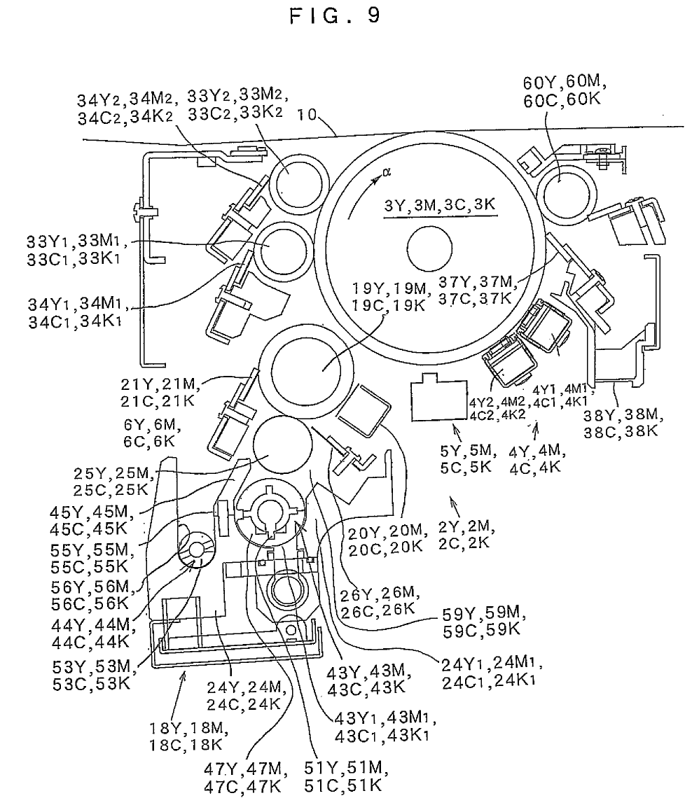

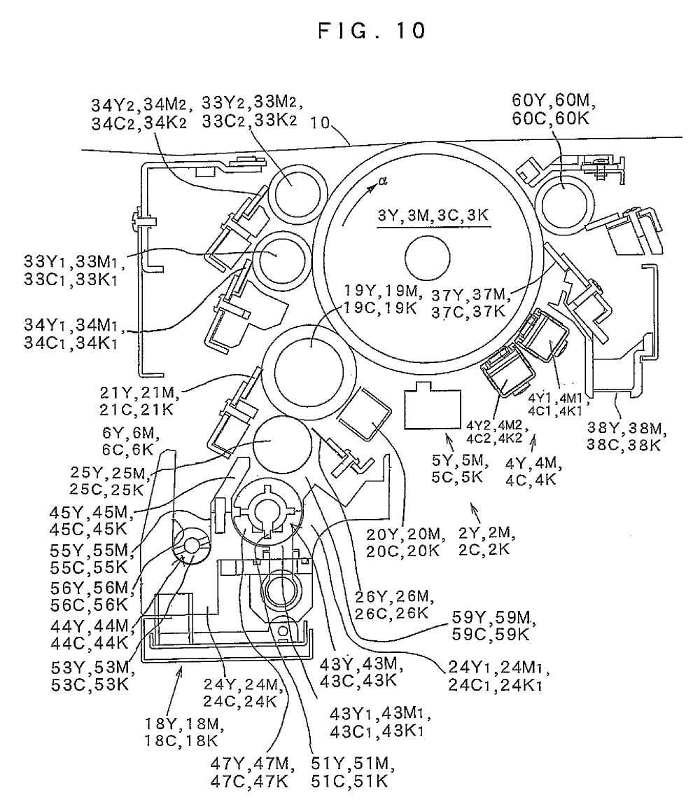

FIG. 9 is an enlarged schematic partial view of the image forming sections of another embodiment of image forming apparatus is according to the present invention, illustrating a state where the developing rollers are separated from the corresponding respective photosensitive members. FIG. 10 is an enlarged schematic partial view of the image forming sections of the embodiment of FIG. 9, illustrating a state where the developing rollers are held in contact with the corresponding respective photosensitive members.

As shown in FIGS. 9 and 10, in the image forming sections 2Y, 2M, 2C and 2K of this embodiment, the oblong liquid developer containers 24Y, 24M, 24C and 24K of the developer supply sections 18Y, 18M, 18C and 18K respectively include liquid developer supply sections 43Y, 43M, 43C and 43K, liquid developer collecting sections 44Y, 44M, 44C and 44K and oblong plate-shaped partition sections 45Y, 45M, 45C and 45K separating the liquid developer supply sections 43Y, 43M, 43C and 43K from the liquid developer collecting sections 44Y, 44M, 44C and 44K.

As shown in FIGS. 9 through 11, supply rollers 46Y, 46M, 46C and 46K are rotatably arranged in the respective liquid developer supply sections 43Y, 43M, 43C and 43K. The supply rollers 46Y, 46M, 46C and 46K respectively have helical first feed blades 47Y, 47M, 47C and 47K that are inclined by a predetermined angle and extend from axial direction middle sections 43Y₁, 43M₁, 43C₁ and 43K₁ toward ones of the axial ends and second feed blades 48Y, 48M, 48C and 48K that are inclined by the same predetermined angle in the opposite direction to show heights same as those of the first feed blades 47Y, 47M, 47C and 47K and arranged at the same ones of the axial ends. The supply rollers 46Y, 46M, 46C and 46K additionally respectively have helical third feed blades 49Y, 49M, 49C and 49K that are inclined by the same predetermined angle in the opposite direction and extend from axial direction middle sections 43Y₁, 43M₁, 43C₁ and 43K₁ toward the other axial ends and fourth feed blades 50Y, 50M, 50C and 50K that are inclined by the same predetermined angel in the opposite direction to show heights same as those of the third feed blades 49Y, 49M, 49C and 49K and arranged at the same other axial ends.

Furthermore, the supply rollers 46Y, 46M, 46C and 46K respectively have first sets of agitation paddles 51Y, 51M, 51C and 51K of a predetermined number (four in the instance of FIG. 9) that extend axially among the first feed blades 47Y, 47M, 47C and 47K and between the first feed blades 47Y, 47M, 47C and 47K and the second feed blades 48Y, 48M, 48C and 48K and arranged at regular intervals. The supply rollers 46Y, 46M, 46C and 46K also respectively have second sets of agitation paddles 52Y, 52M, 52C and 52K of a predetermined number (four in the instance of FIG. 9) that extend axially among the third feed blades 49Y, 49M, 49C and 49K and between the third feed blades 49Y, 49M, 49C and 49K and the fourth feed blades SOY, 50M, 50C and 50K and arranged at regular intervals. The height of the first and second sets of agitation paddles 51Y, 51M, 51C and 51K and 52Y, 52M, 52C and 52K are made to be lower than the height of the first and second feed blades 47Y, 47M, 47C and 47K and 48Y, 48M, 48C and 48K and that of the third and fourth feed blades 49Y, 49M, 49C and 49K and SOY, 50M, 50C and 50K.

Liquid developers are supplied respectively from the agitation units 30Y, 30M, 30C and 30K of the developer supply units 27Y, 27M, 27C and 27K to between the first feed blades 47Y, 47M, 47C and 47K and the corresponding third feed blades 49Y, 49M, 49C and 49K, which are arranged at the axial direction middle sections 43Y₁, 43M₁, 43C₁ and 43K₁ of the liquid developer supply sections 43Y, 43M, 43C and 43K.

As shown in FIGS. 9 through 11, collection screws 53Y, 53M, 53C and 53K are rotatably arranged respectively in the liquid developer collecting sections 44Y, 44M, 44C and 44K. The collection screws 53Y, 53M, 53C and 53K respectively have spiral collection feed blades 54Y, 54M, 54C and 54K that are inclined by a predetermined angle and extend from ones of the axial ends toward the other ends.

As shown in FIGS. 9 and 10, opposite lateral walls 55Y, 55M, 55C and 55K and 56Y, 56M, 56C and 56K of the respective liquid developer collecting sections 44Y, 44M, 44C and 44K that respectively contain the collection feed blades 54Y, 54M, 54C and 54K are arranged substantially in parallel with each other to a predetermined height above the collection feed blades 54Y, 54M, 54C and 54K. With this arrangement, the collection screws 53Y, 53M 53C and 53K can convey the collected respective liquid developers with ease.

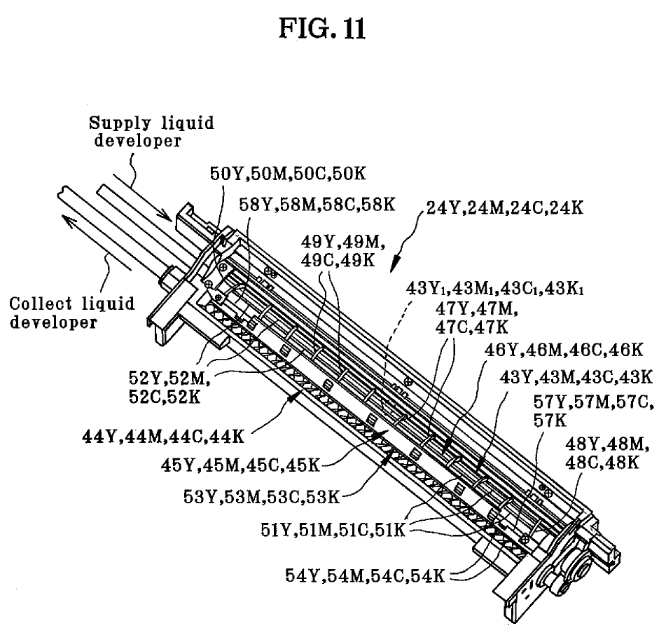

As shown in FIGS. 9 and 10, the partitions sections 45Y, 45M, 45C and 45K are inclined so as to hang over and partly cover upper parts of the respective feed rollers 46Y, 46M, 46C and 46K. As shown in FIG. 11, the partition sections 45Y, 45M, 45C and 45K have first and second low profile sections 57Y, 57M, 57C and 57K and 58Y, 58M, 58C and 58K arranged at the opposite ends thereof. The first low profile sections 57Y, 57M, 57C and 57K are arranged respectively between and vis-à-vis the first and second feed blades 47Y, 47M, 47C and 47K and 48Y, 48M, 48C and 48K. Similarly, the second low profile sections 58Y, 58M, 58C and 58K are arranged respectively between and vis-à-vis the third and fourth feed blades 49Y, 49M, 49C and 49K and SOY, 50M, 50C and 50K.

Thus, liquid developers 23Y, 23M, 23C and 23K are supplied respectively from the developer supply units 27Y, 27M, 27C and 27K to the axial direction middle sections 43Y₁, 43M₁, 43C₁ and 43K₁ of the liquid developer supply sections 43Y, 43M, 43C and 43K. Additionally, liquid developers 23Y, 23M, 23C and 23K are conveyed respectively to the axial direction opposite end sections of the liquid developer supply sections 43Y, 43M, 43C and 43K as the first and third feed blades 47Y, 47M, 47C and 47K and 49Y, 49M, 49C and 49K of the supply rollers 46Y, 46M, 46C and 46K rotate. At this time, liquid developers 23Y, 23M, 23C and 23K are conveyed as they are agitated respectively by the first and second agitation paddles 51Y, 51M, 51C and 51K and 52Y, 52M, 52C and 52K as these agitation paddles are driven to rotate. As liquid developers 23Y, 23M, 23C and 23K are conveyed, they are supplied respectively to the anilox rollers 25Y, 25M, 25C and 25K by the first and third feed blades 47Y, 47M, 47C and 47K and 49Y, 49M, 49C and 49K.

Of the liquid developers conveyed to the opposite end sections of the liquid developer supply sections 43Y, 43M, 43C and 43K, excessive liquid developers 23Y, 23M, 23C and 23K are fed respectively to the liquid developer collecting sections 44Y, 44M, 44C and 44K by way of the first and second low profile sections 57Y, 57M, 57C and 57K and 58Y, 58M, 58C and 58K as the second and fourth feed blades 48Y, 48M, 48C and 48K and 50Y, 50M, 50C and 50K of the supply rollers 46Y, 46M, 46C and 46K and the second agitation paddles 52Y, 52M, 52C and 52K are driven to rotate. The liquid developers 23Y, 23M, 23C and 23K in the liquid developer collecting sections 44Y, 44M, 44C and 44K are collected respectively to the agitation units 30Y, 30M, 30C and 30K of the developer supply units 27Y, 27M, 27C and 27K as the collection feed blades 54Y, 54M, 54C and 54K of the collection screws 53Y, 53M, 53C and 53K are driven to rotate. In this way, liquid developers 23Y, 23M, 23C and 23K are driven to circulate between the agitation units 30Y, 30M, 30C and 30K and the liquid developer containers 24Y, 24M, 24C and 24K. As a result, liquid developers 23Y, 23M, 23C and 23K are prevented from being pooled and compressed at the opposite end sections of the respective liquid developer supply sections 43Y, 43M, 43C and 43K.

As shown in FIGS. 9 and 10, in the developer supply sections 18Y, 18M, 18C and 18K, the spaces 59Y, 59M, 59C and 59Y surrounded respectively by the container main bodies 24Y₁, 24M₁, 24C₁ and 24K₁ of the liquid developer containers 24Y, 24M, 24C and 24K, the anilox rollers 25Y, 25M, 25C and 25K, the developer limiting blades 26Y, 26M, 26C and 26K and the supply rollers 46Y, 46M, 46C and 46K are relatively large. With this arrangement, the toners in the respective spaces 59Y, 59M, 59C and 59Y can hardly be coagulated when they are limited by the developer limiting blades 26Y, 26M, 26C and 26K.

Additionally, as shown in FIGS. 9 and 10, corona chargers are employed for the toner charging units 20Y, 20M, 20C and 20K that are arranged vis-à-vis the respective developing rollers 19Y, 19M, 19C and 19K also in this embodiment. Furthermore, each of the squeezing rollers 33Y, 33M, 33C and 33K of the photosensitive members 3Y, 3M, 3C and 3K includes two squeezing rollers, or a first squeezing roller and a second squeezing roller. Thus, the squeezing rollers 33Y, 33M, 33C and 33K respectively include first squeezing rollers 33Y₁, 33M₁, 33C₁ and 33K₁ and second squeezing rollers 33Y₂, 33M₂, 33C₂ and 33K₂. Then, corresponding to the first and second squeezing rollers 33Y₁, 33M₁, 33C₁ and 33K₁ and 33Y₂, 33M₂, 33C₂ and 33K₂, the squeezing roller cleaning blades 34Y, 34M, 34C and 34K are also made to respectively include first and second squeezing roller cleaning blades 34Y₁, 34M₁, 34C₁ and 34K₁ and 34Y₂, 34M₂, 34C₂ and 34K₂. Still additionally, the charging units 4Y, 4M, 4C and 4K of this embodiment are also made to respectively include first and second charging units 4Y₁, 4M₁, 4C₁ and 4K₁ and 4Y₂, 4M₂, 4C₂ and 4K₂. In other words, this embodiment is adapted to double charging. Note that reference symbols 60Y, 60M, 60C and 60K in FIGS. 9 and 10 denote respective charge elimination units of the photosensitive members.

Otherwise, the image forming apparatus 1 of this embodiment has a configuration same as the one illustrated in FIGS. 1 and 2 and described above.

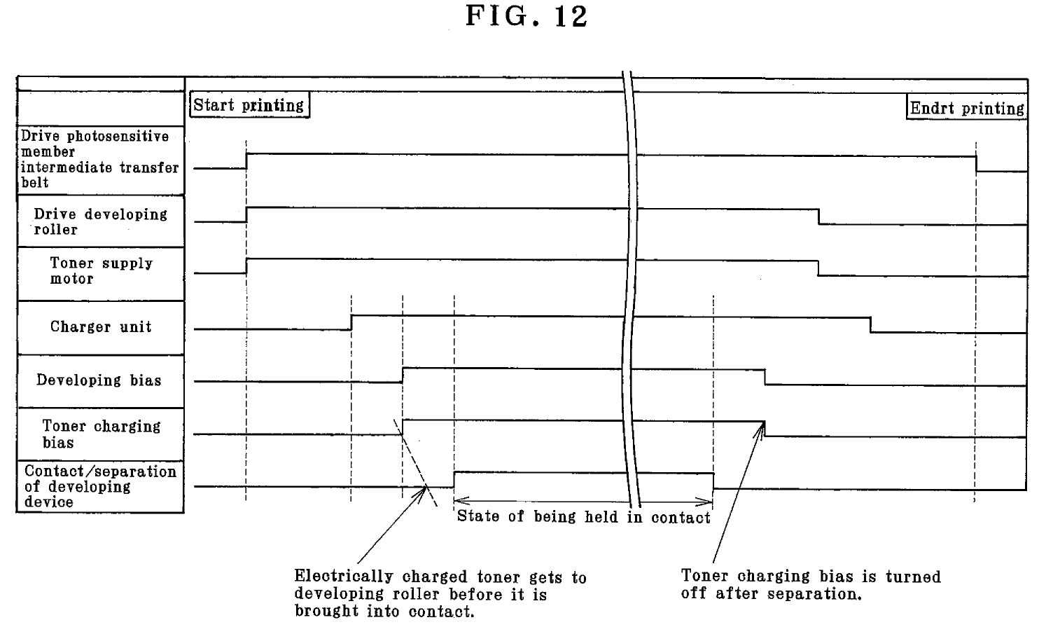

FIG. 12 is a chart illustrating the sequence control of the image forming sections of the image forming apparatus 1 of this embodiment for a printing operation.

As shown in FIG. 12, with the sequence control for a printing operation of this embodiment, when the image forming sections 2Y, 2M, 2C and 2K of the different colors are not operating, the developing units 6Y, 6M, 6C and 6K are separated from the respective photosensitive members 3Y, 3M, 3C and 3K as shown in FIG. 9. A printing operation is started as a printing command is issued as shown in FIG. 12. In other words, the photosensitive members 3Y, 3M, 3C and 3K, the intermediate transfer belt 10, the developing rollers 19Y, 19M, 19C and 19K and the toner supply motor (not shown) start to be driven. When the photosensitive members 3Y, 3M, 3C and 3K, the intermediate transfer belt 10, the developing rollers 19Y, 19M, 19C and 19K and the toner supply motor rotate in a steady state and hence get to respective constant rates of rotations that are set for the image forming operation, the first and second charging units 4Y₁, 4M₁, 4C₁ and 4K₁ and 4Y₂, 4M₂, 4C₂ and 4K₂ begin to be driven to operate. As a result, the photosensitive members 3Y, 3M, 3C and 3K start to be electrically charged.

After the photosensitive members 3Y, 3M, 3C and 3K are uniformly charged, the developing biases are turned on and applied to the developing rollers 19Y, 19M, 19C and 19K and the toner charging biases are turned on by the toner charging units 20Y, 20M, 20C and 20K. Then, the toner charging biases of the toner charging units 20Y, 20M, 20C and 20K respectively get to the toner charging bias levels preset for electrically charging toners. Then, the toners on the respective developing rollers 19Y, 19M, 19C and 19K that are electrically charged to the preset toner charging bias levels pass the respective positions where the developing units 6Y, 6M, 6C and 6K are to be brought into contact with the respective photosensitive members 3Y, 3M, 3C and 3K before the developing units 6Y, 6M, 6C and 6K are actually brought into contact with the photosensitive members 3Y, 3M, 3C and 3K as indicated by dotted lines in FIG. 12. Thereafter, the developing units 6Y, 6M, 6C and 6K are actually brought into contact with the photosensitive members 3Y, 3M, 3C and 3K as shown in FIG. 10. Thus, electrostatic latent images are written respectively by the exposure units 5Y, 5M, 5C and 5K on the photosensitive members 3Y, 3M, 3C and 3K.

Then, the electrostatic images on the photosensitive members 3Y, 3M, 3C and 3K are developed respectively by the toners on the developing rollers 19Y, 19M, 19C and 19K that are electrically charged by the toner charging biases of the present levels and toner images are formed on the respective photosensitive members 3Y, 3M, 3C and 3K. As the development process by the developing rollers is 19Y, 19M, 19C and 19K ends, the developing units 6Y, 6M, 6C and 6K are separated from the respective photosensitive members 3Y, 3M, 3C and 3K. Subsequently, after the developing biases and the toner charging biases are turned off, the developing rollers 19Y, 19M, 19C and 19K and the toner supply motor are stopped. Furthermore, after the charging process by the first and second charging units 4Y₁, 4M₁, 4C₁ and 4K₁ and 4Y₂, 4M₂, 4C₂ and 4K₂ is stopped, the photosensitive members 3Y, 3M, 3C and 3K and the intermediate transfer belt 10 are stopped to end the printing operation.

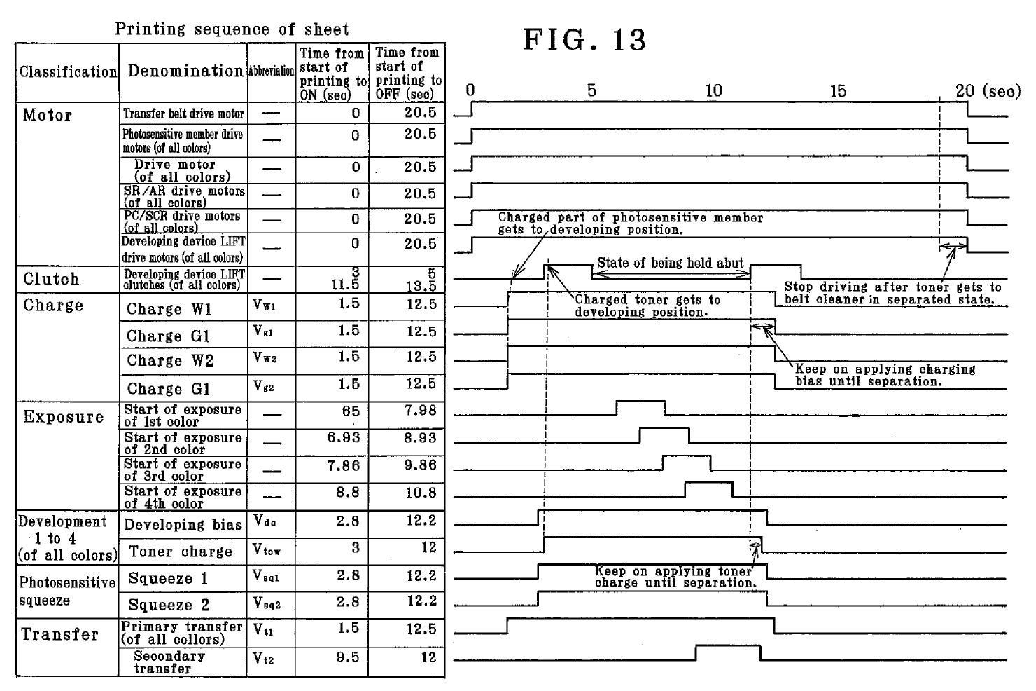

FIG. 13 is a chart illustrating the sequence control of the image forming apparatus of this embodiment for an operation of printing an image on a sheet of printing medium.

As shown in FIG. 13, in the image forming apparatus 1 of this embodiment, the developing units 6Y, 6M, 6C and 6K shown in FIG. 9 are separated from the respective photosensitive members 3Y, 3M, 3C and 3K. A printing operation is started as a printing command is issued. In other words, the drive motor (not shown) of the intermediate transfer belt 10, the drive motors (not shown) of the photosensitive members 3Y, 3M, 3C and 3K of the different colors, the drive motors (not shown) of the developing rollers (DR) 19Y, 19M, 19C and 19K of the different colors and the drive motors (not shown) of the supply rollers (SR) 46Y, 46M, 46C and 46K of the different colors, the drive motors (not shown) of the anilox rollers (AR) 25Y, 25M, 25C and 25K of the different colors, the drive motors (not shown) of the first and second squeezing rollers (SQR) 33Y₁, 33M₁, 33C₁ and 33K₁ and 33Y₂, 33M₂, 33C₂ and 33K₂ of the different colors and the lift drive motors (not shown) of the developing units 6Y, 6M, 6C and 6K all start to be driven.

As a result, photosensitive members 3Y, 3M, 3C and 3K of is the different colors, the anilox rollers (AR) 25Y, 25M, 25C and 25K of the different colors, the intermediate transfer belt 10, the developing rollers (DR) 19Y, 19M, 19C and 19K, the first and second squeezing rollers (SQR) 33Y₁, 33M₁, 33C₁ and 33K₁ and 33Y₂, 33M₂, 33C₂ and 33K₂ of the different colors and the supply rollers (SR) 46Y, 46M, 46C and 46K of the different colors are all driven to rotate. Since the lift clutches (not shown) of the developing units 6Y, 6M, 6C and 6K of the different colors remain off at this time, the developing units 6Y, 6M, 6C and 6K are held in a state of being separated from the respective photosensitive members 3Y, 3M, 3C and 3K. Note that, although not shown in FIG. 13, the collection screws 53Y, 53M, 53C and 53K of the different colors are also driven to rotate.

1.5 sec after the start of the printing operation, the process of electrically charging the photosensitive members 3Y, 3M, 3C and 3K is started respectively by first wire charging biases Vw1 (V), the first grid charging biases Vg1 (V), the second wire charging biases Vw2 (V) and the second grid charging biases Vg2 (V) of the first and second charging units 4Y₁, 4M₁, 4C₁ and 4K₁ and 4Y₂, 4M₂, 4C₂ and 4K₂ and, at the same time, the primary transfer biases Vt1 (V) are applied to the photosensitive members 3Y, 3M, 3C and 3K. Thereafter, the charged parts of the photosensitive members 3Y, 3M, 3C and 3K get to the respective developing positions.

Then, 2.8 sec after the start of the printing operation, the developing biases Vdc (V) are applied to the respective developing rollers 19Y, 19M, 19C and 19K of the different colors. At the same time, the first and second squeezing biases Vsq1 (V) and Vsq2 (V) are applied respectively to the first and second squeezing rollers 33Y₁, 33M₁, 33C₁ and 33K₁ and 33Y₂, 33M₂, 33C₂ and 33K₂ of the different colors.

Subsequently, 3 sec after the start of the printing operation, the lift clutches of the developing units of the different colors are turned on and the process of electrically charging the toners by the toner charging biases Vtcw (V) of the toner charging units 20Y, 20M, 20C and 20K are started. Then, as the lift clutches of the developing units are turned on, the process of moving the developing units 6Y, 6M, 6C and 6K to the respective photosensitive members 3Y, 3M, 3C and 3K is started. Additionally, the electrically charged toners on the developing rollers 19Y, 19M, 19C and 19K get to the respective developing positions. 5 sec after the start of the printing operation, the developing rollers 19Y, 19M, 19C and 19K are brought into contact with the respective photosensitive members 3Y, 3M, 3C and 3K as shown in FIG. 10.

Now, 6 sec after the start of the printing operation, the exposure process of the first color, or yellow (Y), is started and a yellow electrostatic latent image starts to be written onto the photosensitive member 3Y. Then, 6.93 sec after the start of the printing operation, the exposure process of the second color, or magenta (M), is started and a magenta electrostatic latent image starts to be written onto the photosensitive member 3M. Subsequently, 7.86 sec after the start of the printing operation, the exposure process of the third color, or cyan (C), is started and a cyan electrostatic latent image starts to be written onto the photosensitive member 3C. The process of writing the yellow (Y) electrostatic latent image ends 7.98 sec after the start of the printing operation. Then, 8.8 sec after the start of the printing operation, the exposure process of the fourth color, or black (K), is started and a black electrostatic latent image starts is to be written onto the photosensitive member 3K. Thereafter, the process of writing the magenta (M) electrostatic latent image ends 8.93 sec after the start of the printing operation. Then, 9.5 sec after the start of the printing operation, the secondary transfer bias Vt2 (V) is applied. Subsequently, the process of writing the cyan (C) electrostatic latent image ends 9.86 sec after the start of the printing operation. Then, the process of writing the black (K) electrostatic latent image ends 10.8 sec after the start of the printing operation.

The lift clutches of the developing units are turned on once again 11.5 sec after the start of the printing operation to start the process of separating the developing rollers 19Y, 19M, 19C and 19K from the respective photosensitive members 3Y, 3M, 3C and 3K. Then, 12 sec after the start of the printing operation, the toner charging process by the toner charging biases Vtcw (V) ends and also the secondary transfer by the secondary transfer bias Vt2 (V) ends. In other words, the toner charging biases Vtcw (V) are applied until the developing rollers 19Y, 19M, 19C and 19K are separated from the respective photosensitive members 3Y, 3M, 3C and 3K.

The application of the developing biases Vdc (V) and the first and second squeezing biases Vsq1 (V) and Vsq2 (V) are stopped 12.2 sec after the start of the printing operation. Then, 12.5 sec after the start of the printing operation, the application of the charging biases Vw1 (V), Vg1 (V), Vw2 (V) and Vg2 (V) of the first and second charging units 4Y₁, 4M₁, 4C₁ and 4K₁ and 4Y₂, 4M₂, 4C₂ and 4K₂ is stopped and also the application of the primary transfer biases Vt1 (V) is stopped. In other words, the developing biases Vdc (V), the charging biases Vw1 (V), Vg1 (V), Vw2 (V) and Vg2 (V) and the primary transfer biases Vt1 (V) are applied until the developing rollers 19Y, 19M, 19C and 19K are separated from the respective photosensitive members 3Y, 3M, 3C and 3K.

The lift clutches of the developing units are turned off once again 13.5 sec after the start of the printing operation so that the developing rollers 19Y, 19M, 19C and 19K and the respective photosensitive members 3Y, 3M, 3C and 3K are brought into a state of being separated from each other as shown in FIG. 9.

Then, when the developing rollers 19Y, 19M, 19C and 19K are separated from the respective photosensitive members 3Y, 3M, 3C and 3K, the toners of the different colors pass the intermediate transfer belt cleaning blade 17 of the intermediate transfer belt cleaning unit (belt cleaner). Subsequently, 20.5 sec after the start of the printing operation, the drive motor of the intermediate transfer belt 10, the drive motors of the photosensitive members 3Y, 3M, 3C and 3K of the different colors, the drive motors of, the developing rollers (DR) 19Y, 19M, 19C and 19K of the different colors, the drive motors of the supply rollers (SR) 46Y, 46M, 46C and 46K of the different colors, the drive motors of the anilox rollers (AR) 25Y, 25M, 25C and 25K of the different colors, the first and second squeezing rollers (SQR) 33Y₁, 33M₁, 33C₁ and 33K₁ and 33Y₂, 33M₂, 33C₂ and 33K₂ of the different colors and the lift drive motors of the developing units 6Y, 6M, 6C and 6K of the different colors are all stopped.

In this way, the sequence of operation of the image forming apparatus 1 of this embodiment is followed for an operation of printing an image on a sheet of printing medium. While no fixing operation is shown on the printing sequence of FIG. 13, the sequence for an operation of printing an image on a sheet of printing medium includes a fixing process like any other known sequences.

A developing system and an image forming apparatus according to the present invention are by no means limited to the above-described embodiments. In other words, the present invention is applicable to any developing systems and image forming apparatus adapted to develop electrostatic latent images-on the latent image carriers by means of a plurality of liquid developers of different colors and reutilize the residual liquid developers that have not been utilized for the printed image.

1. A developing method comprising:
driving a developing toiler to rotate and supplying liquid developer stored in a liquid developer container to the developing roller;
applying a bias to a toner charger to electrically charge the liquid developer supplied to the developing roller;
driving the developing roller to rotate so as to move the liquid developer electrically charged by the toner charger to a developing position and subsequently bringing the developing roller into contact with a latent image carrier electrically charged by a charger; and
developing the latent image, holding the developing roller in contact with the latent image darner.

2. The developing method according to claim 1, further comprising:
separating the developing roller from the latent image carrier after completing the development;
stopping the application of the bias to the toner charger after separating the developing roller from the latent image carrier; and
stopping the rotation of the developing roller after stopping the application of the bias to the toner charger.

3. An image forming method comprising:
driving a latent image carrier;
charging the latent image bearing member by a charger;
driving a developing roller, supplying liquid developer stored in a liquid developer container to the developing roller and applying a bias to a toner charger to electrically charge the liquid developer supplied to the developing roller;
bringing the liquid developer electrically charged by the toner charger into contact with the latent image carrier electrically charged by the charger;
developing the latent image formed by an exposure unit; and
transferring the image developed on the latent image carrier to a transfer medium held in contact with the latent image carrier.

4. The image forming method according to claim 3, further comprising:
separating the developing roller from the latent image carrier after completing the step of developing the latent image;
stopping the application of the bias to the toner charger; and
stopping the operation of driving the developing roller to rotate.

5. The image forming method according to claim 4, wherein
the latent image carrier is stopped after the developing roller is separated from the latent image carrier and subsequently the developer electrically charged by the toner charger passes a contact section of the latent image carrier and the transfer medium.

6. The image forming method according to claim 4 or 5, further comprising:
driving a transfer member held in contact with the transfer medium and transferring the image transferred from the latent image carrier to the transfer medium further to a recording material; and
cleaning the transfer medium by means of a cleaning member held in contact with the transfer medium after transferring the image to the recording material by the transfer member.

7. The image forming method according to claim 6, wherein
the operation of driving the latent image carrier to rotate is stopped after the liquid developer electrically charged in the step of applying a bias to the toner charger to electrically charge the liquid developer supplied to the developing roller passes a contact section of the transfer medium and the transfer member.

8. The image forming method according to claim 6, wherein
the operation of driving the latent image carrier to rotate is stopped after the liquid developer electrically charged in the step of applying a bias to the toner charger to electrically charge the liquid developer supplied to the developing roller passes a contact section of the transfer medium and the cleaning member.

9. The image forming method according to claim 8, wherein
the operation of driving the developing roller to rotate is stopped after stopping the operation of driving the latent image carrier.

10. An image forming apparatus comprising:
a latent image carrier to be driven to rotate;
a charger for charging the latent image carrier;
an exposure unit for forming a latent image on the latent image carrier;
a developing unit including a liquid developer container storing liquid developer, a developing roller for carrying the liquid developer supplied from the liquid developer container, the developing roller being adapted to be driven to rotate, and a toner charger for applying a charging bias to the liquid developer carried by the developing roller;
contact/separation means that brings the developing roller into contact with and separating it from the latent image carrier; and
controller that causes the developing roller to be driven to rotate, a bias to be applied and charged to the liquid developer supplied to the developing roller by the toner charger, the electrically charged liquid developer to be brought into contact with the latent image carrier electrically charged by the charger by the contact/separation means and the latent image to be developed in a state where the developing roller is held in contact with the latent image carrier.

11. The image forming apparatus according to claim 10, wherein
the controller causes the contact/separation means to separate the developing roller from the latent image carrier after the completion of the development, the toner charger to stop the application of the bias after the developing roller is separated from the latent image carrier and the operation of driving the developing roller to be stopped.

12. The image forming apparatus according to claim 10 or 11, further comprising:
a transfer member that receives the image transferred from the latent image carrier;
a primary transfer member to be brought into contact with the latent image carrier by way of the transfer medium so as to transfer the developed image on the latent image carrier onto the transfer medium;
a secondary transfer member to be brought into contact with the transfer medium so as to transfer the image transferred onto the transfer medium by the primary transfer member further onto the recording material; and
a cleaning member to be brought into contact with the transfer medium after the transfer of the image by the secondary transfer member.

13. The image forming apparatus according to claim 12, wherein
the controller causes the operation of driving the latent image carrier to rotate to be stopped after the liquid developer electrically charged by the toner charger passes a contact section of the transfer medium and the secondary transfer member.

14. The image forming apparatus according to claim 12, wherein
the controller causes the operation of driving the latent image carrier to rotate to be sopped after the liquid developer electrically charged by the toner charger passes a contact section of the transfer medium and the cleaning member.
